(19) United States
(12) Patent Application Publication
(10) Pub. No.: US 2026/0073848 A1
(43) Pub. Date: Mar. 12, 2026

(54) DISPLAY DEVICE AND ELECTRONIC DEVICE INCLUDING THE SAME

(71) Applicant: Samsung Display Co., Ltd., Yongin-si (KR)

(72) Inventors: BYUNGCHANG YU, Yongin-si (KR); Chankeun KWON, Yongin-si (KR); MINKYU WOO, Yongin-si (KR); KYUNGHOON CHUNG, Yongin-si (KR)

(73) Assignee: Samsung Display Co., Ltd., Yongin-si (KR)

(21) Appl. No.: 19/302,326

(22) Filed: Aug. 18, 2025

(30) Foreign Application Priority Data
Sep. 11, 2024 (KR) 10-2024-0123854

(51) Int. Cl. G09G 3/32; G09G 3/3266; G09G 3/3291

(52) U.S. Cl. CPC G09G 3/32; G09G 3/3266; G09G 3/3291; G09G 2300/0857; G09G 2310/0267; G09G 2310/0275; G09G 2310/0286; G09G 2310/0289; G09G 2310/0291; G09G 2310/08; G09G 2320/0257; G09G 2320/066; G09G 2330/022; G09G 2330/023

(57) ABSTRACT

Disclosed is a display device including a display panel including a pixel, a gate driver including a shift register that outputs output signals, and a data driver that supplies a data voltage to the pixel. The shift register includes a first stage that receives a start signal and outputs a first output signal among the output signals and a first carry signal, and a second stage that receives the first carry signal and outputs a second output signal among the output signals and a second carry signal. The first carry signal is a signal delayed from the first output signal, and the second carry signal is a signal delayed from the second output signal.

### CROSS-REFERENCE TO RELATED APPLICATION(S)

This application claims priority to and the benefits of Korean Patent Application No. 10-2024-0123854 under 35 U.S.C. § 119, filed Sep. 11, 2024, in the Korean Intellectual Property Office, the entire contents of which are incorporated herein by reference.

### BACKGROUND

Embodiments described herein relate to a display device and an electronic device including the display device, and more particularly, relate to a display device capable of improving reliability and an electronic device including the display device.

A light emitting display device among display devices displays an image by using a light emitting diode that generates a light through the recombination of electrons and holes. The light emitting display device has a fast response speed and operates with low power consumption.

The display device includes a display panel for displaying an image, a gate driver for sequentially supplying scan signals to scan lines included in the display panel, and a data driver for supplying data signals to data lines included in the display panel.

### SUMMARY

Embodiments provide a display device capable of improving reliability and an electronic device including the display device.

According to an embodiment, a display device may include a display panel including a pixel, a gate driver including a shift register that outputs output signals, and a data driver that supplies a data voltage to the pixel. The shift register may include a first stage that receives a start signal and outputs a first output signal among the output signals and a first carry signal, and a second stage that receives the first carry signal and outputs a second output signal among the output signals and a second carry signal. The first carry signal is a signal delayed from the first output signal, and the second carry signal is a signal delayed from the second output signal.

The first stage may include a 1-1st flip-flop that receives the start signal and outputs the first output signal, and a 1-2nd flip-flop that receives the first output signal and outputs the first carry signal. The second stage may include a 2-1st flip-flop that receives the first carry signal and outputs the second output signal, and a 2-2nd flip-flop that receives the second output signal and outputs the second carry signal.

The 1-1st flip-flop may include a 1-1st latch that receives the start signal and outputs a 1-1st intermediate data, and a 1-2nd latch that receives the 1-1st intermediate data and outputs a 1-1st output data as the first output signal.

The 1-2nd flip-flop may include a 1-3rd latch that receives the 1-1st output data and outputs a 1-2nd intermediate data, and a 1-4th latch that receives the 1-2nd intermediate data and outputs a 1-2nd output data as the first carry signal.

The 1-2nd flip-flop may include a 1-4th latch that receives the 1-1st output data and outputs a 1-2nd output data as the first carry signal.

The first stage may include a first clock generator that receives an external clock. The first clock generator may generate a first internal inversion clock from the external clock, and may generate a first internal clock from the first internal inversion clock. The second stage may include a second clock generator that receives the external clock, and the second clock generator may generate a second internal inversion clock from the external clock, and may generate a second internal clock from the second internal inversion clock.

The 1-1st flip-flop and the 1-2nd flip-flop may respectively output the first output signal and the first carry signal in synchronization with the first internal clock and the first internal inversion clock. The 2-1st flip-flop and the 2-2nd flip-flop may respectively output the second output signal and the second carry signal in synchronization with the second internal clock and the second internal inversion clock.

The 1-1st flip-flop may include a 1-1st clock generator that receives an external clock. The 1-1st clock generator may generate a 1-1st internal inversion clock from the external clock, and may generate a 1-1st internal clock from the 1-1st internal inversion clock. The 1-2nd flip-flop may include a 1-2nd clock generator that receives the external clock. The 1-2nd clock generator may generate a 1-2nd internal inversion clock from the external clock, and may generate a 1-2nd internal clock from the 1-2nd internal inversion clock.

The 1-1st flip-flop may output the first output signal in synchronization with the 1-1st internal clock and the 1-1st internal inversion clock. The 1-2nd flip-flop may output the first carry signal in synchronization with the 1-2nd internal clock and the 1-2nd internal inversion clock.

The 1-1st flip-flop may operate at a rising edge of an external clock, and the 1-2nd flip-flop may operate at a falling edge of the external clock.

The shift register may receive an external clock. A horizontal scan period is defined by the external clock. The first carry signal may be delayed by half the horizontal scan period from the first output signal, and the second carry signal may be delayed by half the horizontal scan period from the second output signal.

The second output signal may be delayed by the horizontal scan period from the first output signal, and the second carry signal may be delayed by the horizontal scan period from the first carry signal.

The gate driver may further include a level shifter that receives the output signals and shifts voltage levels of the output signals, and an output buffer that receives the output signals having the shifted voltage levels and outputs a scan signal.

According to an embodiment, a display device may include a display panel including a pixel, a gate driver including a shift register, and a data driver that supplies a data voltage to the pixel. The shift register may include a plurality of stages. Each of the stages may include a first flip-flop that receives a previous carry signal and may output an output signal, and a second flip-flop that receives the output signal and outputs a current carry signal. The current carry signal is a signal delayed from the output signal.

The first flip-flop may include a 1-1st latch that receives the previous carry signal and outputs a 1-1st intermediate data, and a 1-2nd latch that receives the 1-1st intermediate data and outputs a 1-1st output data as a first output signal.

The second flip-flop may include a 1-3rd latch that receives the 1-1st output data and outputs a 1-2nd intermediate data, and a 1-4th latch that receives the 1-2nd intermediate data and outputs a 1-2nd output data as the current carry signal.

The second flip-flop may include a 1-4th latch that receives the 1-1st output data and outputs a 1-2nd output data as the current carry signal.

The shift register receives an external clock. A horizontal scan period is defined by the external clock. The current carry signal may be delayed by half the horizontal scan period from the output signal.

The gate driver may further include a level shifter that receives the output signal and shifts a voltage level of the output signal, and an output buffer that receives the output signal having the shifted voltage level and outputs a scan signal.

According to an embodiment, an electronic device may include a display panel including a pixel, a gate driver including a shift register that outputs output signals, a data driver that supplies a data voltage to the pixel, a driving controller that receives an image signal and a control signal and controls operations of the gate driver and the data driver, and a main processor that provides the image signal and the control signal to the driving controller. The shift register may include a first stage that receives a start signal and outputs a first output signal among the output signals and a first carry signal, and a second stage that receives the first carry signal and outputs a second output signal among the output signals and a second carry signal. The first carry signal is a signal delayed from the first output signal, and the second carry signal is a signal delayed from the second output signal.

### BRIEF DESCRIPTION OF THE FIGURES

The above and other objects and features of the disclosure will become apparent by describing in detail embodiments thereof with reference to the accompanying drawings.

FIG. 1 is a schematic perspective view of a display device, according to an embodiment.

FIG. 2 is a block diagram of a display device, according to an embodiment.

FIG. 3 is a schematic diagram of an equivalent circuit of a pixel, according to an embodiment.

FIG. 4 is a timing diagram of a pixel, according to an embodiment.

FIG. 5 is a block diagram of a gate driver, according to an embodiment.

FIG. 6 is a block diagram of the first gate driving circuit shown in FIG. 5.

FIG. 7 is a block diagram of a shift register, according to an embodiment.

FIG. 8 is a block diagram of a shift register, according to an embodiment.

FIG. 9 is a schematic diagram of an equivalent circuit of a 1-1st flip-flop, according to an embodiment.

FIG. 10 is a timing diagram of the 1-1st flip-flop shown in FIG. 9.

FIG. 11 is a timing diagram for describing an operation of a shift register, according to an embodiment.

FIG. 12 is a timing diagram for describing an operation of a shift register, according to an embodiment.

FIG. 13 is a block diagram of a shift register, according to an embodiment.

FIG. 14 is a timing diagram for describing an operation of the shift register illustrated in FIG. 13.

FIG. 15 is a timing diagram for describing an operation of the shift register illustrated in FIG. 13.

FIG. 16 is a block diagram of a shift register, according to an embodiment.

FIG. 17 is a timing diagram for describing an operation of the shift register illustrated in FIG. 16.

FIG. 18 is a timing diagram for describing an operation of the shift register illustrated in FIG. 16.

FIG. 19 is a block diagram of an electronic device, according to an embodiment.

FIG. 20A is a drawing showing a smart watch employing a display device, according to an embodiment.

FIG. 20B is a drawing showing a glasses-type virtual reality device employing a display device, according to an embodiment.

### DETAILED DESCRIPTION

In the following description, for the purposes of explanation, numerous specific details are set forth in order to provide a thorough understanding of various embodiments or implementations of the invention. As used herein, “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the scope of the invention.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element or a layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the axis of the first direction DR1, the axis of the second direction DR2, and the axis of the third direction DR3 are not limited to three axes of a rectangular coordinate system, such as the X, Y, and Z-axes, and may be interpreted in a broader sense. For example, the axis of the first direction DR1, the axis of the second direction DR2, and the axis of the third direction DR3 may be perpendicular to one another, or may represent different directions that are not perpendicular to one another. For the purposes of this disclosure, “at least one of A and B” may be understood to mean A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art. For example, “about” may mean within one or more standard deviations, or within ±20%, ±10%, or ±5% of the stated value.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the invention. Further, the blocks, units, and/or modules of some embodiments may be physically combined into more complex blocks, units, and/or modules without departing from the scope of the invention.

Hereinafter, embodiments will be described with reference to accompanying drawings.

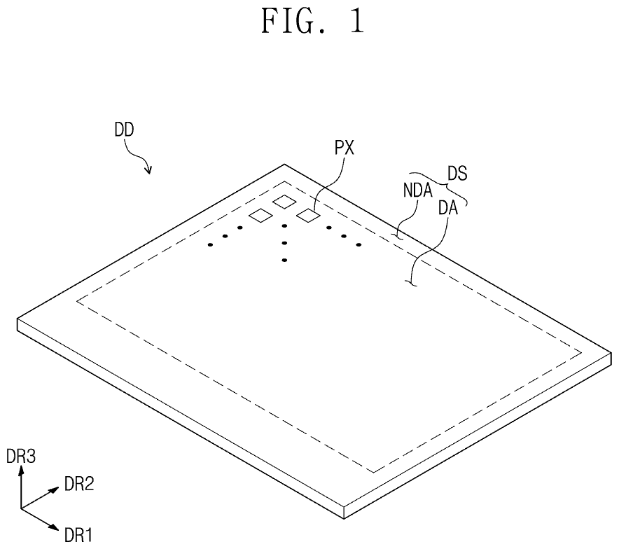

FIG. 1 is a schematic perspective view of a display device, according to an embodiment.

Referring to FIG. 1, a display device DD may have a rectangular shape including long sides parallel to a first direction DR1 and short sides parallel to a second direction DR2 intersecting the first direction DR1. However, an embodiment is not limited thereto, and the display device DD may have various shapes such as a circle or a polygon. Hereinafter, a direction substantially perpendicular to a plane defined by the first direction DR1 and the second direction DR2 is defined as a third direction DR3. In the description, the meaning of “when viewed from above a plane” or “in plan view” may be defined as “when viewed in the third direction DR3”.

The display device DD according to an embodiment may be a device activated according to an electrical signal. The display device DD may be used in a television, a monitor, an outdoor billboard, a tablet PC, a vehicle navigation unit, a personal computer, a notebook computer, a personal digital terminal, a game console, a smartphone, a camera, or a wearable device. For example, the wearable device may include a virtual reality device, an augmented reality device, and a smart watch. The virtual reality device and the augmented reality device may be wearable devices in the form of glasses. These devices are examples. For example, the display device DD may display an image through a display area DA. A non-display area NDA may surround the display area DA. In another example, the non-display area NDA may be positioned to be adjacent to only a single side of the display area DA or may be omitted.

Pixels PX may be disposed in the display area DA. The pixels PX may be arranged in a matrix form. Each of the pixels PX may include a pixel circuit and a light emitting diode. All of the pixels PX may generate light of the same color. Alternatively, the pixels PX may include first pixels that output first color light (e.g., red light), second pixels that output second color light (e.g., green light), and third pixels that output third color light (e.g., blue light). The first pixels, the second pixels, and the third pixels may be disposed in the display area DA.

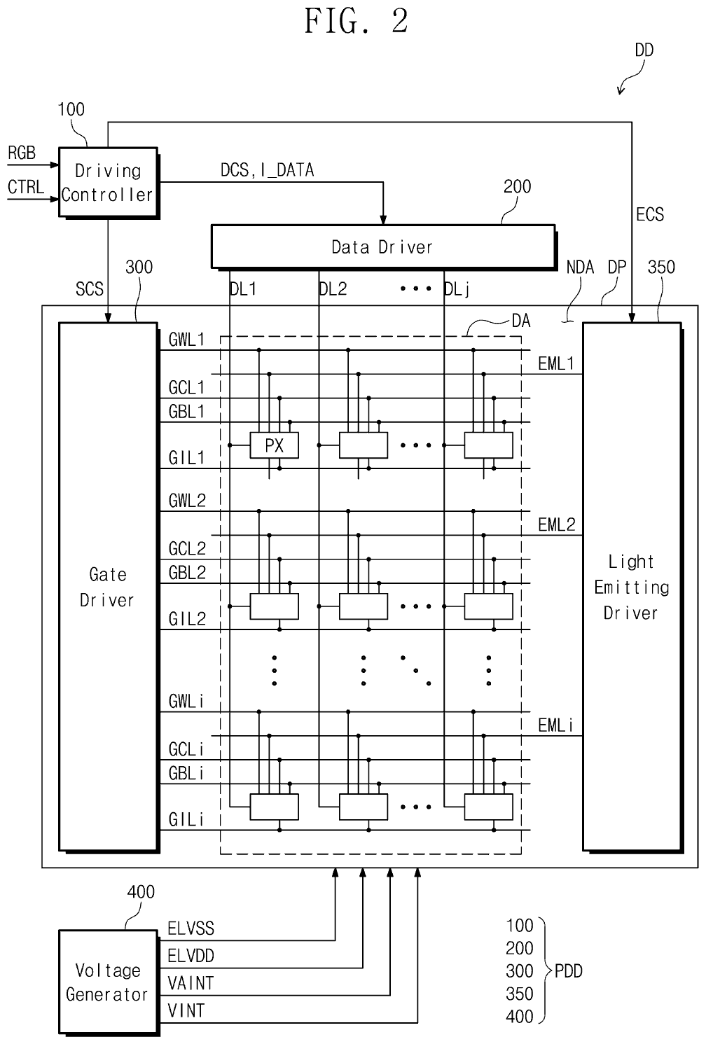

FIG. 2 is a block diagram of a display device, according to an embodiment.

Referring to FIG. 2, the display device DD may include a display panel DP and a panel driver PDD. In an embodiment, the panel driver PDD may include a driving controller 100, a data driver 200, a gate driver 300, a light emitting driver 350, and a voltage generator 400.

The display panel DP may include the display area DA and the non-display area NDA surrounding at least part of the display area DA. The display panel DP may include the pixels PX disposed in the display area DA. The display panel DP may include write scan lines GWL1 to GWLi, compensation scan lines GCL1 to GCLi, initialization scan lines GIL1 to GILi, black scan lines GBL1 to GBLi, and emission control lines EML1 to EMLi. The write scan lines GWL1 to GWLi may be referred to as “first scan lines”. The compensation scan lines GCL1 to GCLi may be referred to as “second scan lines”. The initialization scan lines GIL1 to GILi may be referred to as “third scan lines”. The black scan lines GBL1 to GBLi may be referred to as “fourth scan lines”. Here, ‘i’ may be an integer (or a natural number) greater than or equal to 1.

The driving controller 100 may receive an image signal RGB and a control signal CTRL. The driving controller 100 may generate image data I_DATA by converting a data format of the image signal RGB to comply with the interface specifications of the data driver 200. The driving controller 100 may output a first driving control signal SCS, a second driving control signal DCS, and a third driving control signal ECS.

The data driver 200 may receive the second driving control signal DCS and the image data I_DATA from the driving controller 100. The data driver 200 may convert the image data I_DATA into data signals and may output the data signals to data lines DL1 to DLj. The data signals refer to analog voltages corresponding to grayscale values of the image data I_DATA. Here, ‘j’ may be an integer (or a natural number) greater than or equal to 1.

The gate driver 300 may receive the first driving control signal SCS from the driving controller 100. The gate driver 300 may be connected to the write scan lines GWL1 to GWLi, the compensation scan lines GCL1 to GCLi, the initialization scan lines GIL1 to GILi, and the black scan lines GBL1 to GBLi. The gate driver 300 may output write scan signals, compensation scan signals, initialization scan signals, and black scan signals to the write scan lines GWL1 to GWLi, the compensation scan lines GCL1 to GCLi, the initialization scan lines GIL1 to GILi, and the black scan lines GBL1 to GBLi in response to the first driving control signal SCS, respectively. The write scan signals may be referred to as “first scan signals”. The compensation scan signals may be referred to as “second scan signals”. The initialization scan signals may be referred to as “third scan signals”. The black scan signals may be referred to as “fourth scan signals”.

The light emitting driver 350 may be connected to the emission control lines EML1 to EMLi. The light emitting driver 350 may output emission control signals to the emission control lines EML1 to EMLi in response to the third driving control signal ECS from the driving controller 100.

The gate driver 300 and the light emitting driver 350 may be positioned in the non-display area NDA of the display panel DP. As an example, the gate driver 300 may be positioned adjacent to a first side (e.g., left side) of the display area DA, and the light emitting driver 350 may be adjacent to a second side (e.g., right side) of the display area DA, which is different from the first side. As an example, the second side may be opposite to the first side. In the example shown in FIG. 1, the gate driver 300 and the light emitting driver 350 may be respectively positioned on opposite sides of the display area DA, but embodiments are not limited thereto. For example, the gate driver 300 and the light emitting driver 350 may be positioned adjacent to one of the first side and the second side of the display panel DP. In an embodiment, the gate driver 300 and the light emitting driver 350 may be integrated into a single chip.

The voltage generator 400 (or a power supply unit) may generate voltages for operating the display panel DP. In an embodiment, the voltage generator 400 may generate a first driving voltage ELVDD, a second driving voltage ELVSS, a first initialization voltage VINT, and a second initialization voltage VAINT.

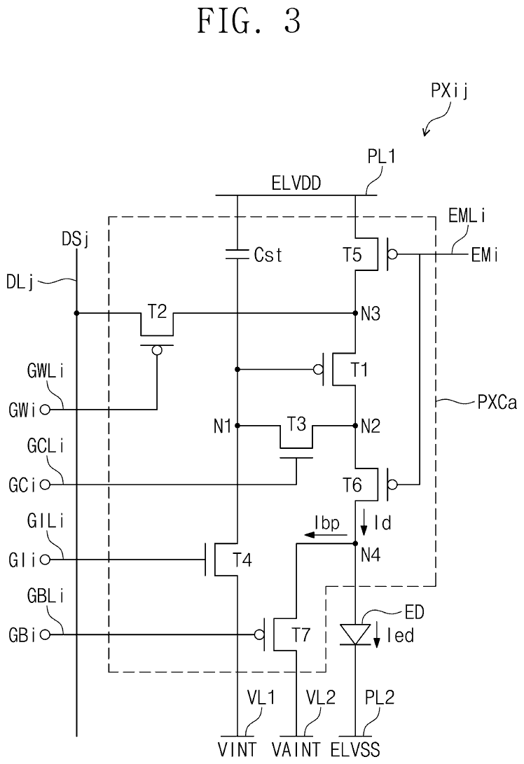

Each of the pixels PX may include a light emitting element ED (see FIG. 3) and a pixel circuit PXCa (see FIG. 3) for controlling the emission of the light emitting element ED. The pixel circuit PXCa may include at least one or more transistors and at least one or more capacitors. The gate driver 300 and the light emitting driver 350 may include transistors formed using the same process used for forming the pixel circuit PXCa.

The pixels PX may be electrically connected to the write scan lines GWL1 to GWLi, the compensation scan lines GCL1 to GCLi, the initialization scan lines GIL1 to GILi, the emission control lines EML1 to EMLi, and the data lines DL1 to DLj. For example, the i-th row of pixels may be connected to the i-th write, compensation, initialization and black scan lines GWLi, GCLi, GILi, and GBLi, and i-th emission control line EMLi. The first column of pixels may be connected to the first data line DL1. However, an embodiment is not limited thereto. For example, each of the pixels PX may be connected to scan lines of which the number is greater than four.

Each of the pixels PX may be connected to a first power line PL1 (see FIG. 3), a second power line PL2 (see FIG. 3), a first initialization voltage line VL1 (see FIG. 3), and a second initialization voltage line VL2 (see FIG. 3). The first power line PL1 may receive the first driving voltage ELVDD from the voltage generator 400. The second power line PL2 may receive the second driving voltage ELVSS from the voltage generator 400. The first initialization voltage line VL1 may receive the first initialization voltage VINT from the voltage generator 400. The second initialization voltage line VL2 may receive the second initialization voltage VAINT from the voltage generator 400.

FIG. 3 is a schematic diagram of an equivalent circuit of a pixel, according to an embodiment.

FIG. 3 representatively shows a pixel PXij connected to the i-th write scan line GWLi among the write scan lines GWL1 to GWLi (see FIG. 2) and the j-th data line DLj among the data lines DL1 to DLj (see FIG. 2). The pixel PXij may be connected to the i-th compensation scan line GCLi among the compensation scan lines GCL1 to GCLi (see FIG. 2), may be connected to the i-th initialization scan line GILi among the initialization scan lines GIL1 to GILi (see FIG. 2), may be connected to the i-th black scan line GBLi among the black scan lines GBL1 to GBLi, and may be connected to the i-th emission control line EMLi (see FIG. 2) among the emission control lines EML1 to EMLi.

The pixel PXij may include the pixel circuit PXCa and the light emitting element ED electrically connected to the pixel circuit PXCa. In an embodiment, the pixel circuit PXCa may include seven transistors (e.g., first to seventh transistors T1 to T7), and one capacitor Cst. Each of the first to seventh transistors T1 to T7 may be a transistor having a low-temperature polycrystalline silicon (LTPS) semiconductor layer. As an example, some of the first to seventh transistors T1 to T7 may be P-type transistors, and the other(s) of the first to seventh transistors T1 to T7 may be N-type transistors. For example, among the first to seventh transistors T1 to T7, the first, second, and fifth to seventh transistors T1, T2, and T5 to T7 may be P-type transistors, and the third and fourth transistors T3 and T4 may be N-type transistors by using an oxide semiconductor as a semiconductor layer. As another example, all of the first to seventh transistors T1 to T7 may be P-type transistors, or all of the first to seventh transistors T1 to T7 may be N-type transistors. However, embodiments are not limited thereto, and structures of various pixel circuits may be applied according to the type and resolution of the display device DD (see FIG. 1).

The i-th write scan line GWLi may deliver an i-th write scan signal GWi to the pixel PXij. The i-th compensation scan line GCLi may deliver an i-th compensation scan signal GCi to the pixel PXij. The i-th initialization scan line GILi may deliver an i-th initialization scan signal Gli to the pixel PXij. The i-th black scan line GBLi may deliver an i-th black scan signal GBi to the pixel PXij. The i-th emission control line EMLi may deliver an i-th emission control signal EMi to the pixel PXij. The j-th data line DLj may deliver a j-th data signal DSj to the pixel PXij. The j-th data signal DSj may have a voltage level corresponding to a grayscale value of the image data signal I_DATA (see FIG. 2) may output from the driving controller 100 (see FIG. 2).

The pixel PXij may be connected to the first power line PL1 for receiving the first driving voltage ELVDD, the second power line PL2 for receiving the second driving voltage ELVSS, the first initialization voltage line VL1 for receiving the first initialization voltage VINT, and the second initialization voltage line VL2 for receiving the second initialization voltage VAINT. The first driving voltage ELVDD may have a higher voltage level than the second driving voltage ELVSS.

The light emitting element ED may include an anode and a cathode. In case that the light emitting element ED is an organic light emitting element, the light emitting element ED may further include an organic layer disposed between an anode and a cathode. The anode of the light emitting element ED may be connected to the pixel circuit PXCa. The cathode of the light emitting element ED may be connected to the second power line PL2. The light emitting element ED may emit light corresponding to the amount of current flowing in the first transistor T1 of the pixel circuit PXCa. However, embodiments are not limited thereto. The light emitting element ED may be an inorganic light emitting element, and may be connected to the anode and cathode included in the display panel DP (see FIG. 2) to emit light in response to the amount of current flowing to the first transistor T1.

The first transistor T1 may be connected between the first power line PL1 for receiving the first driving voltage ELVDD, and the anode of the light emitting element ED. The first transistor T1 may be referred to as a “driving transistor”. The first transistor T1 may include a first electrode, a second electrode, and a gate electrode. The gate electrode may be connected to a first node N1. The first electrode may be connected to a third node N3. The second electrode may be connected to a second node N2. The first electrode may be referred to as a “source of the first transistor T1”. The second electrode may be referred to as a “drain of the first transistor T1”. The first transistor T1 may receive the j-th data signal DSj transmitted by the j-th data line DLj according to the switching operation of the second transistor T2 and then may supply a driving current Id to the light emitting element ED.

The second transistor T2 may be connected between the j-th data line DLj and the third node N3 to receive the i-th write scan signal GWi. The second transistor T2 may be referred to as a “switching transistor”. The second transistor T2 may include a first electrode connected to the j-th data line DLj, a second electrode connected to the third node N3, and a gate electrode connected to the i-th write scan line GWLi. The second transistor T2 may be turned on in response to the i-th write scan signal GWi received through the i-th write scan line GWLi and may transmit the j-th data signal DSj transmitted from the j-th data line DLj to the third node N3.

The third transistor T3 may be connected between the second node N2 and the first node N1 to receive the i-th compensation scan signal GCi. The third transistor T3 may be referred to as a “compensation transistor”. The third transistor T3 may include a first electrode connected to the second node N2, a second electrode connected to the first node N1, and a gate electrode connected to the i-th compensation scan line GCLi. The third transistor T3 may be turned on in response to the i-th compensation scan signal GCi received through the i-th compensation scan line GCLi. Thus, the gate electrode and the second electrode of the first transistor T1 may be connected, and the first transistor T1 may be diode-connected.

The fourth transistor T4 may be connected between the first initialization voltage line VL1 and the first node N1 to receive the i-th initialization scan signal Gli. The fourth transistor T4 may include a first electrode connected to the first initialization voltage line VL1, a second electrode connected to the first node N1, and a gate electrode connected to the i-th initialization scan line GILi. The fourth transistor T4 may be turned on in response to the i-th initialization scan signal Gli received through the i-th initialization scan line GILi such that the first initialization voltage VINT may be applied to the gate electrode of the first transistor T1. Accordingly, an initialization operation may be performed to initialize the potential of the gate electrode (e.g., the first node N1) of the first transistor T1.

The fifth transistor T5 may include a first electrode connected to the first power line PL1, a second electrode connected to the first electrode of the first transistor T1, and a gate electrode connected to the i-th emission control line EMLi.

The sixth transistor T6 may include a first electrode connected to the second electrode of the first transistor T1, a second electrode connected to the anode of the light emitting element ED, and a gate electrode connected to the i-th emission control line EMLi.

The fifth transistor T5 and the sixth transistor T6 may be simultaneously turned on in response to the i-th emission control signal EMi received through the i-th emission control line EMLi. The first driving voltage ELVDD applied through the fifth transistor T5 thus turned on may be compensated through the diode-connected first transistor T1 and then may be applied to the light emitting element ED.

The seventh transistor T7 may be connected between the second initialization voltage line VL2, which provides the second initialization voltage VAINT, and the anode (e.g., a fourth node N4) of the light emitting element ED to receive the i-th black scan signal GBi. The seventh transistor T7 may include a first electrode connected to the second initialization voltage line VL2, a second electrode connected to the anode of the light emitting element ED, and a gate electrode connected to the i-th black scan line GBLi. The seventh transistor T7 may be turned on in response to the i-th black scan signal GBi received through the i-th black scan line GBLi to transmit the second initialization voltage VAINT to the anode of the light emitting element ED. FIG. 3 shows a structure in which the seventh transistor T7 is connected to the i-th black scan line GBLi, but embodiments are not limited thereto. For example, the seventh transistor T7 may be connected to the i-th write scan line GWLi and may receive the i-th write scan signal GWi as the i-th black scan signal GBi.

The capacitor Cst may be connected between the first power line PL1, which provides the first driving voltage ELVDD, and the first node N1. The capacitor Cst may include a first electrode connected to the first power line PL1 and a second electrode connected to the first node N1. The capacitor Cst may store a difference voltage between the first power line PL1 and the first node N1.

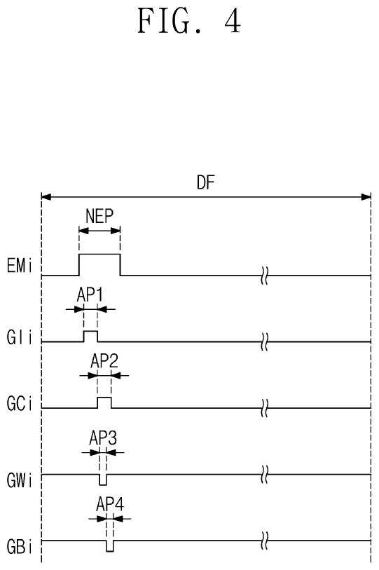

FIG. 4 is a timing diagram of a pixel, according to an embodiment.

Referring to FIGS. 3 and 4, the display panel DP (see FIG. 2) may display an image during a driving frame DF.

The scan signals Gli, GCi, GWi, and GBi may be activated during the driving frame DF. For example, the initialization scan signal Gli may include a first active period AP1 that has a high level during the driving frame DF, and the compensation scan signal GCi may include a second active period AP2 that has a high level during the driving frame DF. The write scan signal GWi may include a third active period AP3 which has a low level in the driving frame DF. The black scan signal GBi may include a fourth active period AP4 which has a low level in the driving frame DF.

The emission control signal EMi may include a non-emission period NEP, which is deactivated during the driving frame DF. As an example, the non-emission period NEP may be a high-level period. The non-emission period NEP may overlap the first to fourth active periods AP1, AP2, AP3, and AP4.

In case that the initialization scan signal Gli having a high level is provided through the initialization scan line GILi during the first active period AP1, the fourth transistor T4 may be turned on in response to the initialization scan signal Gli having the high level. The first initialization voltage VINT may be applied to the gate electrode of the first transistor T1 through the turned-on fourth transistor T4, and the gate electrode of the first transistor T1 may be initialized by the first initialization voltage VINT.

Next, in case that the compensation scan signal GCi having a high level is supplied through the compensation scan line GCLi during the second active period AP2, the third transistor T3 may be turned on. During the second active period AP2, the first transistor T1 may be diode-connected by the third transistor T3 turned on and may be forward-biased. The second active period AP2 of the compensation scan signal GCi may not overlap the first active period AP1 of the initialization scan signal Gli. Moreover, the first active period AP1 of the initialization scan signal Gli may precede or may be before the second active period AP2 of the compensation scan signal GCi.

In an embodiment, the second active period AP2 of the compensation scan signal GCi may be defined as a period in which the compensation scan signal GCi has a high level. The first active period AP1 of the initialization scan signal Gli may be defined as a period in which the initialization scan signal Gli has a high level. In case that the third and fourth transistors T3 and T4 are P-type transistors, the first active period AP1 of the initialization scan signal Gli may be defined as a period during which the initialization scan signal Gli has a low level, and the second active period AP2 of the compensation scan signal GCi may be defined as a period during which the compensation scan signal GCi has a low level.

The second active period AP2 may overlap the third active period AP3 in which the write scan signal GWi is generated at a low level. During the third active period AP3, the second transistor T2 may be turned on by the write scan signal GWi having a low level. Then, a compensation voltage “DSj-Vth” obtained by reducing the data signal DSj supplied from the data line DLj by the threshold voltage Vth of the first transistor T1 may be applied to the gate electrode of the first transistor T1. For example, the potential of the gate electrode of the first transistor T1 may be the compensation voltage “DSj-Vth”.

The first driving voltage ELVDD and the compensation voltage “DSj-Vth” may be respectively applied to end portions (e.g., opposite end portions) of the capacitor Cst, and charges corresponding to a voltage difference between the end portions (e.g., opposite end portions) of the capacitor Cst may be stored in the capacitor Cst.

Afterward, during the fourth active period AP4, the seventh transistor T7 may be turned on by receiving the black scan signal GBi having the low level through the black scan line GBLi. A portion of the driving current Id may be drained through the seventh transistor T7 as a bypass current Ibp.

In the case where the pixel PXij displays a black image, in case that the light emitting element ED emits light even though the minimum driving current of the first transistor T1 flows as the driving current Id, the pixel PXij may not normally display a black image. Accordingly, the seventh transistor T7 in the pixel PXij according to an embodiment may drain, flow, or disperse a part of the minimum driving current of the first transistor T1 to a current path, which is different from a current path to the light emitting element ED, as the bypass current Ibp. For example, the minimum driving current of the first transistor T1 means the current flowing into the first transistor T1 under the condition that the first transistor T1 is turned off because a gate-source voltage Vgs of the first transistor T1 is less than the threshold voltage Vth. As the minimum driving current (e.g., a current of 10 pA or less) flowing to the first transistor T1 is transferred to the light emitting element ED under the condition that the first transistor T1 is turned off, an image of a black gray scale may be displayed. In case that the pixel PXij displays a black image, the bypass current Ibp may have a relatively large influence on the minimum driving current. In case that the pixel PXij displays an image such as a normal image or a white image, the bypass current Ibp may have little effect on the driving current Id. Accordingly, in case that a black image is displayed, a current that corresponds to a result of subtracting the bypass current Ibp flowing through the seventh transistor T7 from the driving current Id may be provided to the light emitting element ED, and thus a black image may be clearly displayed. Accordingly, the pixel PXij may implement an accurate black grayscale image by using the seventh transistor T7, and thus a contrast ratio may be improved.

Next, the emission control signal EMi supplied from the emission control line EMLi may be changed from a high level to a low level. The fifth transistor T5 and the sixth transistor T6 may be turned on in response to the emission control signal EMi having a low level. For example, the driving current Id according to a voltage difference between the gate voltage of the gate electrode of the first transistor T1 and the first driving voltage ELVDD may be generated and supplied to the light emitting element ED through the sixth transistor T6, and an emission current led flows through the light emitting element ED.

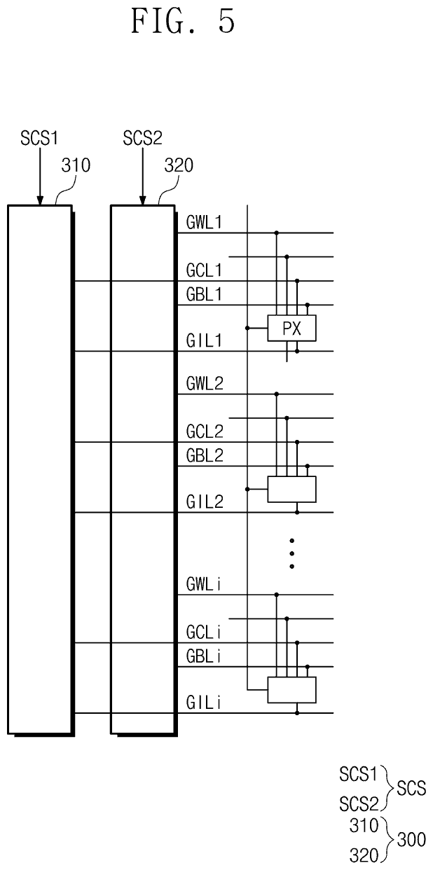

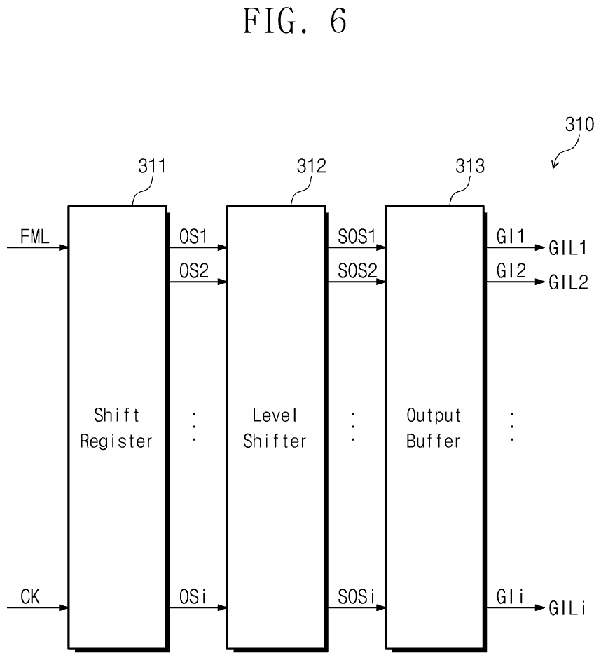

FIG. 5 is a block diagram of a gate driver, according to an embodiment. FIG. 6 is a block diagram of the first gate driving circuit shown in FIG. 5.

Referring to FIG. 5, the gate driver 300 may include a first gate driving circuit 310 and a second gate driving circuit 320. The first driving control signal SCS may include a 1-1st driving control signal SCS1 received by the first gate driving circuit 310 from the driving controller 100 (see FIG. 2) and a 1-2nd driving control signal SCS2 received by the second gate driving circuit 320 from the driving controller 100. The first and second gate driving circuits 310 and 320 may output scan signals to the scan lines in response to the 1-1st and 1-2nd driving control signals SCS1 and SCS2. Although FIG. 5 illustrates a configuration in which the gate driver 300 includes two gate driving circuits 310 and 320, the number of gate driving circuits included in the gate driver 300 is not limited thereto.

In response to the 1-1st driving control signal SCS1, the first gate driving circuit 310 may output initialization scan signals to the initialization scan lines GIL1 to GILi and may output compensation scan signals to the compensation scan lines GCL1 to GCLi. In response to the 1-2nd driving control signal SCS2, the second gate driving circuit 320 may output write scan signals to the write scan lines GWL1 to GWLi and may output black scan signals to the black scan lines GBL1 to GBLi.

FIG. 6 illustrates the first gate driving circuit 310. Referring to FIG. 6, the first gate driving circuit 310 may include a shift register 311, a level shifter 312, and an output buffer 313. The 1-1st driving control signal SCS1 (see FIG. 5) may include a start signal FLM and an external clock CK. The start signal FLM and the external clock CK may be provided to the shift register 311.

The shift register 311 may sequentially output output signals OS1 to OSi in response to the start signal FLM and the external clock CK.

The level shifter 312 may shift voltage levels of the output signals OS1 to OSi to appropriate voltage levels for driving the pixel PX (see FIG. 2) and may output shift output signals SOSI to SOSi. The output signals OS1 to OSi and the shift output signals SOSI to SOSi may have different amplitudes.

The output buffer 313 may be connected to the initialization scan lines GIL1 to GILi. The output buffer 313 may output the shift output signals SOSI to SOSi, whose voltage levels are shifted by the level shifter 312, as the initialization scan signals GI1 to Gli to the initialization scan lines GIL1 to GILi, respectively. For convenience of description, FIG. 6 illustrates that the output buffer 313 outputs only the initialization scan signals GI1 to Gli, but the output buffer 313 may be connected to the compensation scan lines GCL1 to GCLi (see FIG. 5) to output compensation scan signals.

The second gate driving circuit 320 may have a similar configuration to the first gate driving circuit 310. For example, the second gate driving circuit 320 may include the shift register 311, the level shifter 312, and the output buffer 313, which receive the 1-2nd driving control signal SCS2. The output buffer 313 may be connected to the write scan lines GWL1 to GWLi (see FIG. 5) and the black scan lines GBL1 to GBLi (see FIG. 5) to output write scan signals and black scan signals.

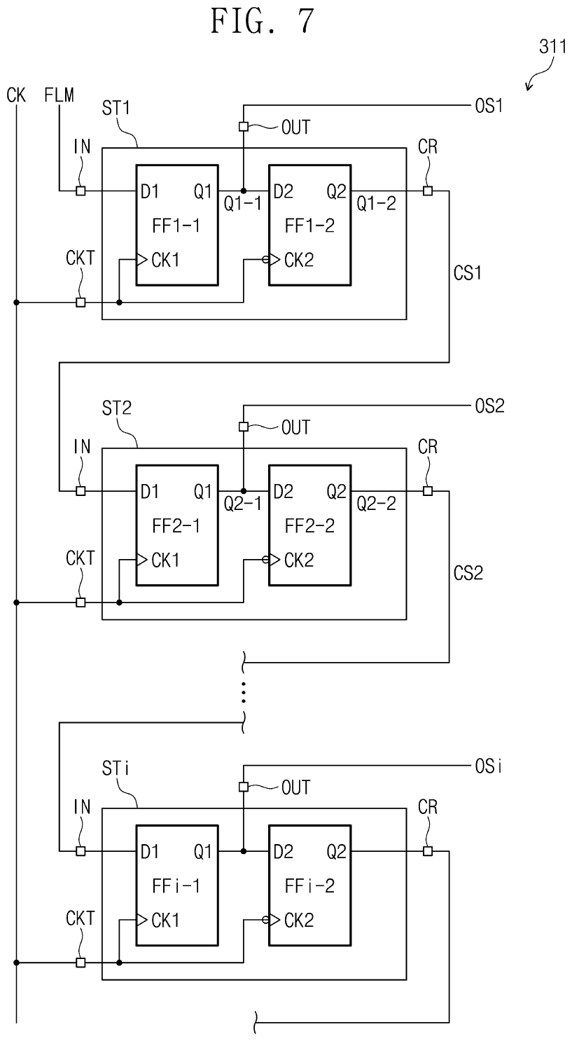

FIG. 7 is a block diagram of a shift register, according to an embodiment.

Referring to FIGS. 6 and 7, the shift register 311 may include stages ST1 and ST2 to STi. The stages ST1 to STi may be connected sequentially. The stages ST1 to STi may have substantially the same circuit configurations as each other. Accordingly, only the three stages ST1, ST2, and STi are illustrated in FIG. 7.

Each of the stages ST1 to STi may include an input terminal IN, a clock terminal CKT, a carry terminal CR, and an output terminal OUT.

The input terminal IN may receive the start signal FLM or a carry signal (hereinafter referred to as a “previous carry signal”) output from the carry terminal CR of the previous stage. The input terminal IN of the first stage ST1 may receive the start signal FLM. The input terminal IN of the second stage ST2 may receive the first carry signal output from the carry terminal CR of the first stage ST1 as the previous carry signal.

Each of the stages ST1 to STi may sequentially output the output signals OS1 to OSi to the level shifter 312. The first stage ST1 may output the first output signal OS1. The second stage ST2 may output the second output signal OS2. The i-th stage STi may output the i-th output signal OSi. The stages ST1 to STi may output carry signals CS1 to CSi, respectively. The first stage ST1 may output the first carry signal CS1 through the carry terminal CR, the second stage ST2 may output the second carry signal CS2 through the carry terminal CR and the i-th stage STi may output the i-th carry signal (or dummy signal) through the carry terminal CR.

The first stage ST1 may include a 1-1st flip-flop FF1-1 and a 1-2nd flip-flop FF1-2. The second stage ST2 may include a 2-1st flip-flop FF2-1 and a 2-2nd flip-flop FF2-2. The i-th stage STi may include an i-1st flip-flop FFi-1 and an i-2nd flip-flop FFi-2. As an example, each of the 1-1st to i-2nd flip-flops FF1-1 to FFi-2 may be a D-flip-flop.

The 1-1st flip-flop FF1-1 may receive the external clock CK and the start signal FLM, and may output the first output signal OS1. The first output signal OS1 may be a signal delayed by a predetermined (or selected) time from the start signal FLM. A voltage level of the first output signal OS1 may be shifted through the level shifter 312, and the first output signal OS1 may be provided as the first initialization scan signal GI1 to the first row of pixels PX (see FIG. 2) through the output buffer 313. The 1-2nd flip-flop FF1-2 may receive the external clock CK and the first output signal OS1 from the 1-1st flip-flop FF1-1 and may output the first carry signal CS1. The first carry signal CS1 may be a signal delayed by a predetermined (or selected) time from the first output signal OS1.

The 2-1st flip-flop FF2-1 may receive the external clock CK and the first carry signal CS1 (e.g., the previous carry signal) from the 1-2nd flip-flop FF1-2 and may output the second output signal OS2. The second output signal OS2 may be a signal delayed by a predetermined (or selected) time from the first carry signal CS1. A voltage level of the second output signal OS2 may be shifted through the level shifter 312, and the second output signal OS2 may be provided as the second initialization scan signal GI2 to the second row of pixels PX (see FIG. 2) through the output buffer 313. The 2-2nd flip-flop FF2-2 may receive the external clock CK and the second output signal OS2 from the 2-1st flip-flop FF2-1, and may output the second carry signal CS2 (e.g., the current carry signal). The second carry signal CS2 may be a signal delayed by a predetermined (or selected) time from the second output signal OS2.

A first input data terminal D1 of the 1-1st flip-flop FF1-1 may be connected to the input terminal IN of the first stage ST1, and a first clock terminal CK1 of the 1-1st flip-flop FF1-1 may be connected to the clock terminal CKT of the first stage ST1. The 1-1st flip-flop FF1-1 may receive the start signal FLM through the first input data terminal D1 and may receive the external clock CK through the first clock terminal CK1. The 1-1st flip-flop FF1-1 may generate a 1-1st output data Q1-1 by using the external clock CK and the start signal FLM, and may output the 1-1st output data Q1-1 to a first output data terminal Q1 of the 1-1st flip-flop FF1-1. The first output data terminal Q1 of the 1-1st flip-flop FF1-1 may be connected to the output terminal OUT of the first stage ST1. Accordingly, the output terminal OUT of the first stage ST1 may output the 1-1st output data Q1-1 as the first output signal OS1.

A second input data terminal D2 of the 1-2nd flip-flop FF1-2 may be connected to the first output data terminal Q1 of the 1-1st flip-flop FF1-1, and a second clock terminal CK2 of the 1-2nd flip-flop FF1-2 may be connected to the clock terminal CKT of the first stage ST1. The 1-2nd flip-flop FF1-2 may receive the 1-1st output data Q1-1 through the second input data terminal D2 and may receive the external clock CK through the second clock terminal CK2. The 1-2nd flip-flop FF1-2 may generate a 1-2nd output data Q1-2 by using the external clock CK and the 1-1st output data Q1-1, and may output the 1-2nd output data Q1-2 to a second output data terminal Q2 of the 1-2nd flip-flop FF1-2. The second output data terminal Q2 of the 1-2nd flip-flop FF1-2 may be connected to the carry terminal CR of the first stage ST1. Accordingly, the carry terminal CR of the first stage ST1 may output the 1-2nd output data Q1-2 as the first carry signal CS1.

The 1-1st output data Q1-1 of the 1-1st flip-flop FF1-1 may be provided as input data to the second input data terminal D2 of the 1-2nd flip-flop FF1-2, and may be output as the first output signal OS1 through the output terminal OUT. The 1-2nd output data Q1-2 (e.g., the first carry signal CS1) of the 1-2nd flip-flop FF1-2 may be provided as input data to the first input data terminal D1 of the 2-1st flip-flop FF2-1. A 2-1st output data Q2-1 of the 2-1st flip-flop FF2-1 may be provided as input data to the second input data terminal D2 of the 2-2nd flip-flop FF2-2, and may be output as the second output signal OS2 through the output terminal. A 2-2nd output data Q2-2 of the 2-2nd flip-flop FF2-2 may be output as the second carry signal CS2.

For example, the 1-1st to i-1st flip-flops FF1-1 to FFi-1 (referred to as a “first flip-flop”) may respectively receive previous carry signals from the input terminal IN of the stages ST1 to STi and may respectively output the output signals OS1 to OSi to the output terminals OUT of the stages ST1 to STi. The 1-2nd to i-2nd flip-flops FF1-2 to FFi-2 (referred to as a “second flip-flop”) may respectively receive the output signals OS1 to OSi from the 1-1st to i-1st flip-flops FF1-1 to FFi-1 and may respectively output current carry signals to the carry terminals CR of the stages ST1 to STi.

Each of the 1-1st to i-1st flip-flops FF1-1 to FFi-1 may receive the external clock CK and may operate at a rising edge, which is a point in time in case that the external clock CK changes from a low level to a high level. Each of the 1-2nd to i-2nd flip-flops FF1-2 to FFi-2 may receive the external clock CK and may operate at a falling edge, which is a point in time in case that the external clock CK changes from a high level to a low level. Each of the 1-1st to i-1st flip-flop FF1-1 to FFi-1 may be referred to as a rising edge trigger flip-flop. Each of the 1-2nd to i-2nd flip-flops FF1-2 to FFi-2 may be referred to as a falling edge trigger flip-flop. For another example, each of the 1-1st to i-1st flip-flops FF1-1 to FFi-1 may operate on the falling edge, and each of the 1-2nd to i-2nd flip-flops FF1-2 to FFi-2 may operate on the rising edge.

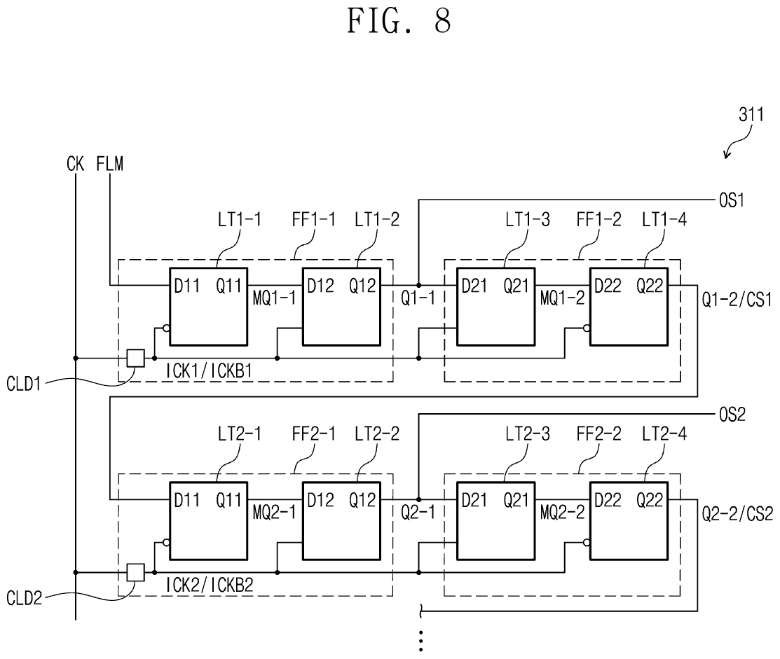

FIG. 8 is a block diagram of a shift register, according to an embodiment.

Referring to FIGS. 7 and 8, the 1-1st flip-flop FF1-1 may include a first clock generation unit CLD1, a 1-1st latch LT1-1, and a 1-2nd latch LT1-2.

The first clock generation unit CLD1 may receive the external clock CK. The first clock generation unit CLD1 may generate a first internal inversion clock ICKB1 and a first internal clock ICK1 by using the external clock CK. The first clock generation unit CLD1 may be connected to the 1-1st latch LT1-1 and the 1-2nd latch LT1-2 and may provide the first internal inversion clock ICKB1 and the first internal clock ICK1 to the 1-1st latch LT1-1 and the 1-2nd latch LT1-2.

The 1-1st latch LT1-1 may receive the start signal FLM through a 1-1st input data terminal D11, and may output a 1-1st intermediate data MQ1-1 through a 1-1st output data terminal Q11 in synchronization with the first internal inversion clock ICKB1 and the first internal clock ICK1. The 1-2nd latch LT1-2 may receive the 1-1st intermediate data MQ1-1 output from the 1-1st latch LT1-1 through a 1-2nd input data terminal D12, and may output the 1-1st output data Q1-1 in synchronization with the first internal inversion clock ICKB1 and the first internal clock ICK1. The 1-1st output data Q1-1 may be provided as the first output signal OS1 to the level shifter 312 (see FIG. 6).

The 1-2nd flip-flop FF1-2 may include a 1-3rd latch LT1-3 and a 1-4th latch LT1-4.

The first clock generation unit CLD1 may be connected to the 1-3rd latch LT1-3 and the 1-4th latch LT1-4 and may provide the first internal inversion clock ICKB1 and the first internal clock ICK1 to the 1-3rd latch LT1-3 and the 1-4th latch LT1-4.

The 1-3rd latch LT1-3 may receive the 1-1st output data Q1-1 through a 2-1st input data terminal D21, and may output a 1-2nd intermediate data MQ1-2 in synchronization with the first internal inversion clock ICKB1 and the first internal clock ICK1. The 1-4th latch LT1-4 may receive the 1-2nd intermediate data MQ1-2 from the 1-3rd latch LT1-3 through a 2-2nd input data terminal D22 and may output the 1-2nd output data Q1-2 in synchronization with the first internal inversion clock ICKB1 and the first internal clock ICK1. The 1-2nd output data Q1-2 may be provided to the second stage ST2 as the first carry signal CS1.

The 2-1st flip-flop FF2-1 may include a second clock generation unit CLD2, a 2-1st latch LT2-1, and a 2-2nd latch LT2-2.

The second clock generation unit CLD2 may receive the external clock CK. The second clock generation unit CLD2 may generate a second internal inversion clock ICKB2 and a second internal clock ICK2 by using the external clock CK. The second clock generation unit CLD2 may be connected to the 2-1st latch LT2-1 and the 2-2nd latch LT2-2 and may provide the second internal inversion clock ICKB2 and the second internal clock ICK2 to the 2-1st latch LT2-1 and the 2-2nd latch LT2-2.

The 2-1st latch LT2-1 may receive the first carry signal CS1 from the 1-4th latch LT1-4 through the 1-1st input data terminal D11 and may output a 2-1st intermediate data MQ2-1 through the 1-1st output data terminal Q11 in synchronization with the second internal inversion clock ICKB2 and the second internal clock ICK2. The 2-2nd latch LT2-2 may receive the 2-1st intermediate data MQ2-1 output from the 2-1st latch LT2-1 through the 1-2nd input data terminal D12 and may output the 2-1st output data Q2-1 in synchronization with the second internal inversion clock ICKB2 and the second internal clock ICK2. The 2-1st output data Q2-1 may be provided as the second output signal OS2 to the level shifter 312 (see FIG. 6).

The 2-2nd flip-flop FF2-2 may include a 2-3rd latch LT2-3 and a 2-4th latch LT2-4.

The second clock generation unit CLD2 may be connected to the 2-3rd latch LT2-3 and the 2-4th latch LT2-4 and may provide the second internal inversion clock ICKB2 and the second internal clock ICK2 to the 2-3rd latch LT2-3 and the 2-4th latch LT2-4.

The 2-3rd latch LT2-3 may receive the 2-1st output data Q2-1 through the 2-1st input data terminal D21, and may output a 2-2nd intermediate data MQ2-2 in synchronization with the second internal inversion clock ICKB2 and the second internal clock ICK2. The 2-4th latch LT2-4 may receive the 2-2nd intermediate data MQ2-2 from the 2-3rd latch LT2-3 through the 2-2nd input data terminal D22 and may output the 2-2nd output data Q2-2 in synchronization with the second internal inversion clock ICKB2 and the second internal clock ICK2. The 2-2nd output data Q2-2 may be provided to the next stage as the second carry signal CS2.

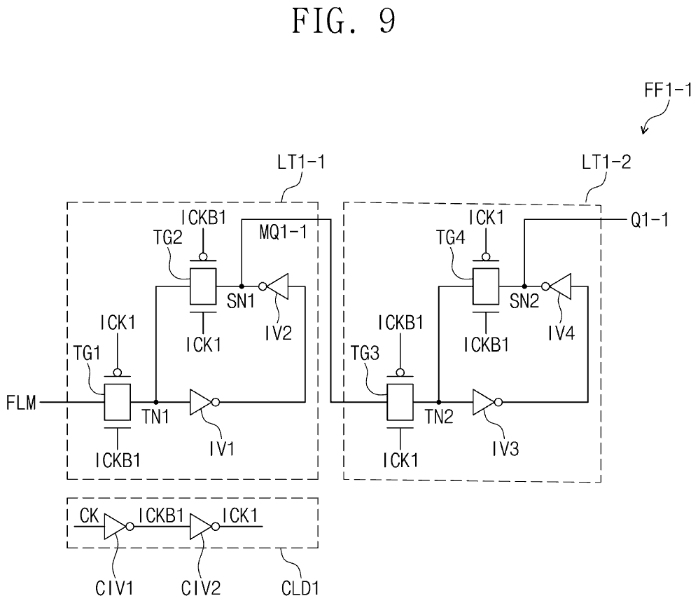

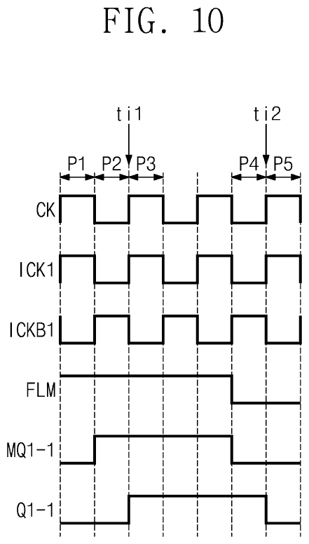

FIG. 9 is a schematic diagram of an equivalent circuit of a 1-1st flip-flop, according to an embodiment. FIG. 10 is a timing diagram of the 1-1st flip-flop shown in FIG. 9.

Referring to FIGS. 9 and 10, the 1-1st flip-flop FF1-1 may include the first clock generation unit CLD1, the 1-1st latch LT1-1, and the 1-2nd latch LT1-2.

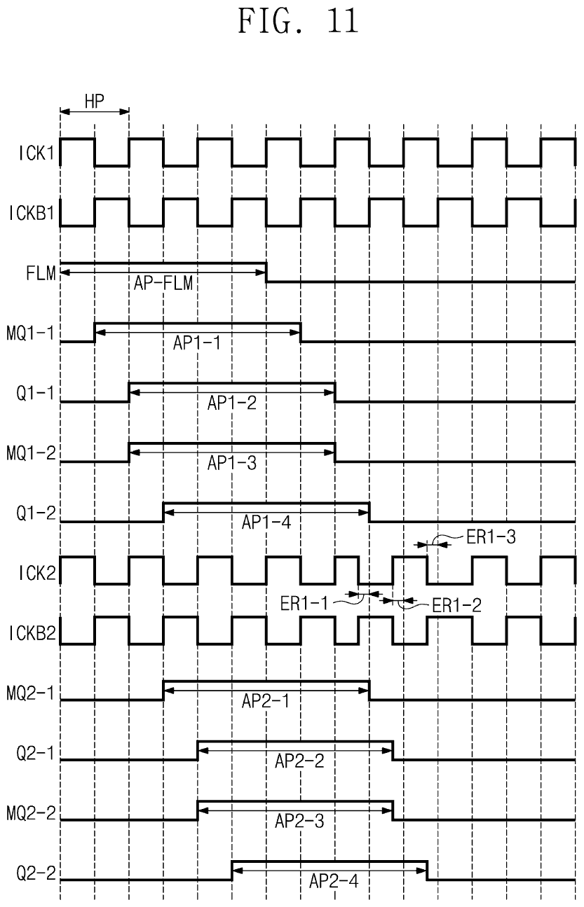

The first clock generation unit CLD1 may include a first clock inverter CIV1 for inverting the external clock CK to the first internal inversion clock ICKB1 and a second clock inverter CIV2 for inverting the first internal inversion clock ICKB1 to the first internal clock ICK1. The first internal inversion clock ICKB1 may have a phase inverted (or opposite) to a phase of the external clock CK. The first internal clock ICK1 may have a phase inverted (or opposite) to a phase of the first internal inversion clock ICKB1, or may have the same phase as the phase of the external clock CK. The external clock CK, the first internal clock ICK1, and the first internal inversion clock ICKB1 may be signals that swing at a predetermined (or selected) period (e.g., a horizontal scan period HP (see FIG. 11)) during the driving frame DF (scc FIG. 4).

FIG. 9 illustrates an embodiment (e.g., a structure in which the clock generation unit provided in the 1-1st flip-flop FF1-1 is also connected to the 1-2nd flip-flop FF1-2 of the first stage ST1) in which a clock generation unit is included in the 1-1st flip-flop FF1-1 and the clock generation unit is included in each stage, but embodiments are not limited thereto. For example, the clock generation unit may be provided for each flip-flop or for each shift register.

The 1-1st latch LT1-1 may include first and second transmission gates TG1 and TG2 and may include first and second inverters IV1 and IV2. The 1-2nd latch LT1-2 may include third and fourth transmission gates TG3 and TG4 and may include third and fourth inverters IV3 and IV4.

Each of the first to fourth transmission gates TG1 to TG4 may include a single PMOS transistor and a single NMOS transistor connected in parallel with the PMOS transistor. Each of the first to fourth transmission gates TG1 to TG4 may transmit an input signal.

Each of the gate electrodes of the PMOS transistors of the first and fourth transmission gates TG1 and TG4 may receive the first internal clock ICK1, and each of the gate electrodes of the NMOS transistors of the first and fourth transmission gates TG1 and TG4 may receive the first internal inversion clock ICKB1. In case that the first internal inversion clock ICKB1 is at a low level (or in case that the external clock CK is at a high level), the first and fourth transmission gates TG1 and TG4 may be turned off. In case that the first internal inversion clock ICKB1 is at a high level (or in case that the external clock CK is at a low level), the first and fourth transmission gates TG1 and TG4 may be turned on. For example, the first and fourth transmission gates TG1 and TG4 may perform signal transmission functions in case that the first internal inversion clock ICKB1 is at a high level, and may not perform the signal transmission functions in case that the first internal inversion clock ICKB1 is at a low level.

The gate electrodes of the PMOS transistors of the second and third transmission gates TG2 and TG3 may receive the first internal inversion clock ICKB1, and the gate electrodes of the NMOS transistors of the second and third transmission gates TG2 and TG3 may receive the first internal clock ICK1. In case that the first internal clock ICK1 is at a high level (or in case that the external clock CK is at a high level), the second and third transmission gates TG2 and TG3 may be turned on. In case that the first internal clock ICK1 is at a low level (or in case that the external clock CK is at a low level), the second and third transmission gates TG2 and TG3 may be turned off. For example, the second and third transmission gates TG2 and TG3 may perform signal transmission functions in case that the first internal clock ICK1 is at a high level, and may not perform the signal transmission functions in case that the first internal clock ICK1 is at a low level. For example, in case that the first transmission gate TG1 is turned on, the second transmission gate TG2 may be turned off. In case that the first transmission gate TG1 is turned off, the second transmission gate TG2 may be turned on. Moreover, in case that the third transmission gate TG3 is turned on, the fourth transmission gate TG4 may be turned off. In case that the third transmission gate TG3 is turned off, the fourth transmission gate TG4 may be turned on.

Each of the first to fourth inverters IV1 to IV4 may invert the phase of the input signal.

The first inverter IV1 may be connected to the first transmission gate TG1 and may invert the signal transmitted from the first transmission gate TG1. The second inverter IV2 may be connected to the first inverter IV1 and may invert the signal inverted through the first inverter IV1 again. A node to which the first transmission gate TG1, the first inverter IV1, and the second transmission gate TG2 are connected may be referred to as a “first transmission node TN1”. A node to which the second transmission gate TG2 and the second inverter IV2 are connected is referred to as a “first storage node SN1”. The second transmission gate TG2 may be connected between the first transmission node TN1 and the first storage node SN1.

The third transmission gate TG3 may be connected between the first storage node SN1 and the third inverter IV3. The third inverter IV3 may invert the signal transmitted from the third transmission gate TG3. The fourth inverter IV4 may be connected to the third inverter IV3 and may invert the inverted signal through the third inverter IV3 again. A node to which the third transmission gate TG3, the third inverter IV3, and the fourth transmission gate TG4 are connected is referred to as a “second transmission node TN2”. A node to which the fourth transmission gate TG4 and the fourth inverter IV4 are connected is referred to as a “second storage node SN2”. The fourth transmission gate TG4 is connected between the second transmission node TN2 and the second storage node SN2.

In case that the first internal inversion clock ICKB1 is at a high level, the first transmission gate TG1 may be turned on, and thus transmits the start signal FLM to the first transmission node TN1. In case that the first internal inversion clock ICKB1 is at a low level, the first transmission gate TG1 may block the start signal FLM from being transmitted to the first transmission node TN1. For example, the start signal FLM may be converted into the 1-1st intermediate data MQ1-1 by the on/off operation of the first transmission gate. The 1-1st intermediate data MQ1-1 may be stored in the first storage node SN1 through the first and second inverters IV1 and IV2. In case that the first transmission gate TG1 is turned on, the second transmission gate TG2 may be turned off, and thus the first transmission node TN1 and the first storage node SN1 may be separated from each other by the second transmission gate TG2, thereby preventing the data of the first transmission node TN1 and the data of the first storage node SN1 from colliding (or being merged) with each other. In the meantime, in case that the first transmission gate TG1 is turned off, the second transmission gate TG2 may be turned on, and thus the second transmission gate TG2 may connect the first transmission node TN1 and the first storage node SN1. Accordingly, although the start signal FLM is blocked, the 1-1st intermediate data MQ1-1 may be provided to the first transmission node TN1.

In case that the first transmission gate TG1 is turned on, the third transmission gate TG3 may be turned off. Accordingly, in case that the first transmission gate TG1 is turned on, the third transmission gate TG3 may separate the 1-1st latch LT1-1 and the 1-2nd latch LT1-2, thereby blocking the 1-1st intermediate data MQ1-1 from being transmitted to the 1-2nd latch LT1-2. For example, the fourth transmission gate TG4 is turned on, and thus the 1-1st output data Q1-1 stored in the second storage node SN2 may be continuously maintained.

In case that the first transmission gate TG1 is turned off, the third transmission gate TG3 may be turned on. In case that the first internal clock ICK1 is at a high level, the third transmission gate TG3 may be turned on to transmit the 1-1st intermediate data MQ1-1 to the second transmission node TN2. In case that the first internal clock ICK1 is at a low level, the third transmission gate TG3 may be turned off to block the 1-1st intermediate data MQ1-1 from being transmitted to the second transmission node TN2. For example, the 1-1st intermediate data MQ1-1 may be converted into the 1-1st output data Q1-1 by the on/off operation of the third transmission gate TG3. The 1-1st output data Q1-1 may be stored in the second storage node SN2 through the third and fourth inverters IV3 and IV4. In case that the third transmission gate TG3 is turned on, the fourth transmission gate TG4 may be turned off, and thus the second transmission node TN2 and the second storage node SN2 may be separated from each other by the fourth transmission gate TG4, thereby preventing the data of the second transmission node TN2 and the data of the second storage node SN2 from colliding (or being merged) with each other. In the meantime, in case that the first transmission gate TG1 is turned off, the fourth transmission gate TG4 may be turned on, and thus the fourth transmission gate TG4 may connect the second transmission node TN2 and the second storage node SN2. Accordingly, although the 1-1st intermediate data MQ1-1 is blocked, the 1-1st output data Q1-1 may be provided to the second transmission node TN2.

As a result, in case that the first internal inversion clock ICKB1 is at a high level, the 1-1st latch LT1-1 may output the start signal FLM as the 1-1st intermediate data MQ1-1. In case that the first internal inversion clock ICKB1 is at a low level, the 1-1st latch LT1-1 may keep the 1-1st intermediate data MQ1-1 as the previous data value. In case that the first internal clock ICK1 is at a high level, the 1-2nd latch LT1-2 may output the 1-1st intermediate data MQ1-1 as the 1-1st output data Q1-1. In case that the first internal clock ICK1 is at a low level, the 1-1st first output data Q1-1 may be maintained as the previous data value.

In a first period P1, the first internal clock ICK1 may have a high level, and the first internal inversion clock ICKB1 may have a low level. In the first period P1, the first internal inversion clock ICKB1 may have a low level, and thus the first transmission gate TG1 may be turned off. Accordingly, even in the first period P1, the 1-1st intermediate data MQ1-1 may be maintained at a voltage level (e.g., a low level) of the 1-1st intermediate data MQ1-1 in the previous period as it is. During the first period P1, the third transmission gate TG3 may be turned on and the 1-1st intermediate data MQ1-1 may be transmitted to the second transmission node TN2. Because the 1-1st intermediate data MQ1-1 has a low level during the first period P1, the 1-1st output data Q1-1 may have a low level.

In a second period P2, the first internal clock ICK1 may have a low level, and the first internal inversion clock ICKB1 may have a high level. In the second period P2, the first internal inversion clock ICKB1 may have a high level, and thus the first transmission gate TG1 may be turned on. Because the start signal FLM has a high level in the second period P2, the 1-1st intermediate data MQ1-1 may have a high level. During the second period P2, the third transmission gate TG3 may be turned off to block the 1-1st intermediate data MQ1-1 from being transmitted to the second transmission node TN2. Accordingly, even in the second period P2, the 1-1st output data Q1-1 may be maintained at a low level of the 1-1st output data Q1-1 in the first period P1 as it is.

In a third period P3, the first internal clock ICK1 may have a high level, and the first internal inversion clock ICKB1 may have a low level. In the third period P3, the first internal inversion clock ICKB1 may have a low level, and thus the first transmission gate TG1 may be turned off. Accordingly, even in the third period P3, the 1-1st intermediate data MQ1-1 may be maintained at a high level of the 1-1st intermediate data MQ1-1 in the second period P2 as it is. During the third period P3, the third transmission gate TG3 may be turned on and the 1-1st intermediate data MQ1-1 may be transmitted to the second transmission node TN2. Because the 1-1st intermediate data MQ1-1 has a high level during the third period P3, the 1-1st output data Q1-1 may have a high level.

In a fourth period P4, the first internal clock ICK1 may have a low level, and the first internal inversion clock ICKB1 may have a high level. In the fourth period P4, the first internal clock ICK1 may have a low level, and thus the first transmission gate TG1 may be turned on. Because the start signal FLM has a low level in the fourth period P4, the 1-1st intermediate data MQ1-1 may have a low level. During the fourth period P4, the third transmission gate TG3 may be turned off to block the 1-1st intermediate data MQ1-1 from being transmitted to the second transmission node TN2. Accordingly, even in the fourth period P4, the 1-1st output data Q1-1 may be maintained at a high level of the 1-1st output data Q1-1 in the third period P3 as it is.

In a fifth period P5, the first internal clock ICK1 may have a high level, and the first internal inversion clock ICKB1 may have a low level. In the fifth period P5, the first internal inversion clock ICKB1 may have a low level, and thus the first transmission gate TG1 may be turned off. Accordingly, even in the fifth period P5, the 1-1st intermediate data MQ1-1 may be maintained at a low level of the 1-1st intermediate data MQ1-1 in the fourth period P4 as it is. During the fifth period P5, the third transmission gate TG3 may be turned on and the 1-1st intermediate data MQ1-1 may be transmitted to the second transmission node TN2. Because the 1-1st intermediate data MQ1-1 has a low level during the fifth period P5, the 1-1st output data Q1-1 may have a low level.

Accordingly, the 1-1st flip-flop FF1-1 may output the start signal FLM as the 1-1st output data Q1-1 at first and second time points ti1 and ti2 (e.g., a rising edge), which are time points at which the external clock CK changes from a low level to a high level. For example, because the start signal FLM of the 1-1st flip-flop FF1-1 has a high level at the first time point ti1, the 1-1st output data Q1-1 may change to a high level. The 1-1st flip-flop FF1-1 may have a low level at the second time point ti2, and thus the 1-1st output data Q1-1 may change to a low level.

FIG. 9 illustrates the 1-1st flip-flop FF1-1. However, the 1-2nd flip-flop FF1-2 (see FIG. 7) may be configured such that data output as the 1-2nd output data Q1-2 changes at the time point (e.g., a falling edge) at which the external clock CK changes from a high level to a low level. For example, in the case of the 1-2nd flip-flop FF1-2, each of the gate electrodes of the PMOS transistors of the first and fourth transmission gates TG1 and TG4 may receive the first internal inversion clock ICKB1, and each of the gate electrodes of the NMOS transistors of the first and fourth transmission gates TG1 and TG4 may receive the first internal clock ICK1. Moreover, each of the gate electrodes of the PMOS transistors of the second and third transmission gates TG2 and TG3 may receive the first internal clock ICK1, and each of the gate electrodes of the NMOS transistors of the second and third transmission gates TG2 and TG3 may receive the first internal inversion clock ICKB1. Accordingly, a time point at which data output as the 1-2nd output data Q1-2 of the 1-2nd flip-flop FF1-2 changes may be a time point (e.g., a falling edge) at which the external clock CK changes from a high level to a low level.

FIG. 11 is a timing diagram for describing an operation of a shift register, according to an embodiment.

Referring to FIGS. 8 and 11, the 1-1st to 1-4th latches LT1-1 to LT1-4 output the 1-1st and 1-2nd intermediate data MQ1-1 and MQ1-2 and the 1-1st and 1-2nd output data Q1-1 and Q1-2 in synchronization with the first internal clock ICK1 and the first internal inversion clock ICKB1. The first internal clock ICK1 and the first internal inversion clock ICKB1 may be generated from the first clock generation unit CLD1.

The 1-1st latch LT1-1 may receive the start signal FLM having a start active period AP-FLM and may output the 1-1st intermediate data MQ1-1 having a 1-1st active period AP1-1. The 1-1st active period AP1-1 may be initiated at a time point, at which the first internal inversion clock ICKB1 has a high level and the start signal FLM has a high level, and may end at a time point at which the first internal inversion clock ICKB1 has a high level and the start signal FLM has a low level.

The 1-2nd latch LT1-2 may receive the 1-1st intermediate data MQ1-1 and may output the 1-1st output data Q1-1 having a 1-2nd active period AP1-2. The 1-2nd active period AP1-2 may start at a time point, at which the first internal clock ICK1 has a high level and the 1-1st intermediate data MQ1-1 has a high level, and may end at a time point when the first internal clock ICK1 has a high level and the 1-1st intermediate data MQ1-1 has a low level.

The 1-3rd latch LT1-3 may receive the 1-1st output data Q1-1 and may output the 1-2nd intermediate data MQ1-2 having a 1-3rd active period AP1-3. The 1-3rd active period AP1-3 may start at a time point, at which the first internal clock ICK1 has a high level and the 1-1st output data Q1-1 has a high level, and may end at a time point at which the first internal clock ICK1 has a high level and the 1-1st output data Q1-1 has a low level.

The 1-4th latch LT1-4 may receive the 1-2nd intermediate data MQ1-2 and may output the 1-2nd output data Q1-2 having a 1-4th active period AP1-4. The 1-4th active period AP1-4 may start at a time point, at which the first internal inversion clock ICKB1 has a high level and the 1-2nd intermediate data MQ1-2 has a high level, and may end at a time point at which the first internal inversion clock ICKB1 has a high level and the 1-2nd intermediate data MQ1-2 has a low level.

The 2-1st to 2-4th latches LT2-1 to LT2-4 may output the 2-1st and 2-2nd intermediate data MQ2-1 and MQ2-2, and the 2-1st and 2-2nd may output data Q2-1 and Q2-2 in synchronization with the second internal clock ICK2 and the second internal inversion clock ICKB2. The second internal clock ICK2 and the second internal inversion clock ICKB2 may be generated from the second clock generation unit CLD2. FIG. 11 illustrates a case in which errors occur in the second internal clock ICK2 and the second internal inversion clock ICKB2.

The 2-1st latch LT2-1 may receive the 1-2nd output data Q1-2 from the 1-4th latch LT1-4 and may output the 2-1st intermediate data MQ2-1 having a 2-1st active period AP2-1. The 2-1st active period AP2-1 may start at a time point, at which the second internal inversion clock ICKB2 has a high level and the 1-2nd output data Q1-2 has a high level, and may end at a time point at which the second internal inversion clock ICKB2 has a high level and the 1-2nd output data Q1-2 has a low level.

In a 1-1st error period ER1-1, the first internal inversion clock ICKB1 may have a low level, and the second internal inversion clock ICKB2 may have a high level. Although the second internal inversion clock ICKB2 has a high level in the 1-1st error period ER1-1, the 1-2nd output data Q1-2 may have a high level, and thus the 2-1st intermediate data MQ2-1 may maintain a high level.

The 2-2nd latch LT2-2 may receive the 2-1st intermediate data MQ2-1 and may output the 2-1st output data Q2-1 having a 2-2nd active period AP2-2. The 2-2nd active period AP2-2 may start at a time point, at which the second internal clock ICK2 has a high level and the 2-1st intermediate data MQ2-1 has a high level, and may end at a time point when the second internal clock ICK2 has a high level and the 2-1st intermediate data MQ2-1 has a low level.

In a 1-2nd error period ER1-2, the first internal clock ICK1 may have a low level and the second internal clock ICK2 may have a high level. Because the second internal clock ICK2 has a high level in the 1-2nd error period ER1-2, the 2-1st output data Q2-1 may change to a low level.

The 2-3rd latch LT2-3 may receive the 2-1st output data Q2-1 and may output the 2-2nd intermediate data MQ2-2 having a 2-3rd active period AP2-3. The 2-3rd active period AP2-3 may start at a time point, at which the second internal clock ICK2 has a high level and the 2-1st intermediate data MQ2-1 has a high level, and may end at a time point at which the second internal clock ICK2 has a high level and the 2-1st output data Q2-1 has a low level.

In the 1-2nd error period ER1-2, the first internal clock ICK1 may have a low level and the second internal clock ICK2 may have a high level. In the 1-2nd error period ER1-2, the second internal clock ICK2 may have a high level and the 2-1st output data Q2-1 may have a low level, and thus the 2-2nd intermediate data MQ2-2 may change to a low level.

The 2-4th latch LT2-4 may receive the 2-2nd intermediate data MQ2-2 and may output the 2-2nd output data Q2-2 having a 2-4th active period AP2-4. The 2-4th active period AP2-4 may start at a time point, at which the second internal inversion clock ICKB2 has a high level and the 2-2nd intermediate data MQ2-2 has a high level, and may end at a time point at which the second internal inversion clock ICKB2 has a high level and the 2-2nd intermediate data MQ2-2 has a low level.

In a 1-3rd error period ER1-3, the first internal inversion clock ICKB1 may have a low level, and the second internal inversion clock ICKB2 may have a high level. In the 1-3rd error period ER1-3, the second internal inversion clock ICKB2 may have a high level and the 2-2nd intermediate data MQ2-2 may have a low level, and thus the 2-2nd output data Q2-2 may be identified as a low level.

The 1-2nd output data Q1-2 (e.g., the first carry signal CS1) may be a signal delayed by half a horizontal scan period HP from the 1-1st output data Q1-1 (e.g., the first output signal OS1). The 2-2nd output data Q2-2 (e.g., the second carry signal CS2) may be a signal delayed by half the horizontal scan period HP from the 2-1st output data Q2-1 (the second output signal OS2).

As an example, the second carry signal CS2 may be a signal delayed by the horizontal scan period HP from the first carry signal CS1. The second output signal OS2 may be a signal delayed by the horizontal scan period HP from the first output signal OS1.

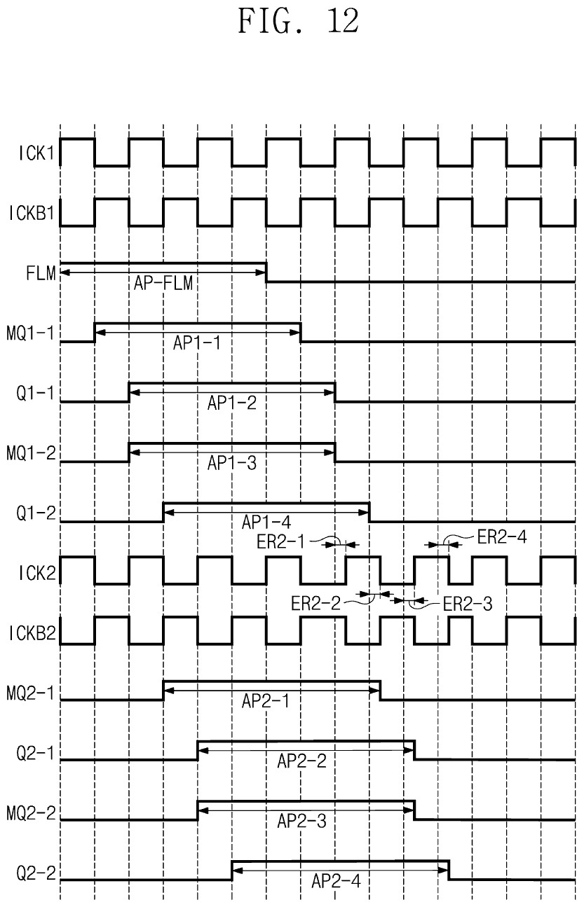

FIG. 12 is a timing diagram for describing an operation of a shift register, according to an embodiment.

Referring to FIGS. 8 and 12, the 2-1st to 2-4th latches LT2-1 to LT2-4 may output the 2-1st and 2-2nd intermediate data MQ2-1 and MQ2-2 and the 2-1st and 2-2nd output data Q2-1 and Q2-2 in synchronization with the second internal clock ICK2 and the second internal inversion clock ICKB2. The second internal clock ICK2 and the second internal inversion clock ICKB2 may be generated from the second clock generation unit CLD2 (scc FIG. 8).

In the timing diagram of FIG. 12, a process in which each of latches receives input data and may output the input data as output data is similar to an operation of each of the latches in the timing diagram of FIG. 11, and thus redundant descriptions are omitted for descriptive convenience. FIG. 12 illustrates a case in which errors occur in the second internal clock ICK2 and the second internal inversion clock ICKB2.

In a 2-1st error period ER2-1, the first internal inversion clock ICKB1 may have a low level, and the second internal inversion clock ICKB2 may have a high level. In the 2-1st error period ER2-1, the second internal inversion clock ICKB2 may have a high level and the 1-2nd output data Q1-2 may have a high level. Accordingly, the 2-1st intermediate data MQ2-1 may have a high level.

In a 2-2nd error period ER2-2, the first internal inversion clock ICKB1 may have a high level, and the second internal inversion clock ICKB2 may have a low level. Because the second internal inversion clock ICKB2 has a low level in the 2-2nd error period ER2-2, the 2-1st intermediate data MQ2-1 may maintain a high level as it is.

In a 2-3rd error period ER2-3, the first internal clock ICK1 may have a high level, and the second internal clock ICK2 may have a low level. Because the second internal clock ICK2 has a low level in the 2-3rd error period ER2-3, the 2-1st output data Q2-1 may maintain a high level as it is. Because the second internal clock ICK2 has a low level in the 2-3rd error period ER2-3, the 2-2nd intermediate data MQ2-2 may maintain a high level as it is.

In a 2-4th error period ER2-4, the first internal inversion clock ICKB1 may have a low level, and the second internal inversion clock ICKB2 may have a high level. Because the second internal inversion clock ICKB2 has a low level in the 2-4th error period ER2-4, the 2-2nd output data Q2-2 may maintain a high level as it is.

According to an embodiment, a hold margin corresponding to half of the horizontal scan period HP (see FIG. 11) may be additionally ensured by additionally providing the 1-2nd flip-flop FF1-2. Accordingly, although the first internal inversion clock ICKB1 and the second internal inversion clock ICKB2 have different phases from each other in the 2-1st error period ER2-1, the 2-1st latch LT2-1 may receive the 1-2nd output data Q1-2 delayed by a predetermined (or selected) time from the 1-1st output data Q1-1 and may output the 2-1st intermediate data MQ2-1. Accordingly, the 2-1st intermediate data MQ2-1 may maintain a high level as it is.

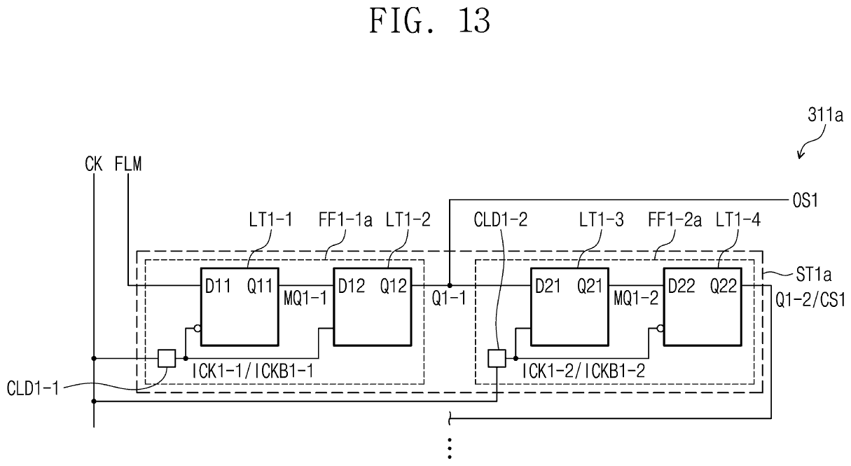

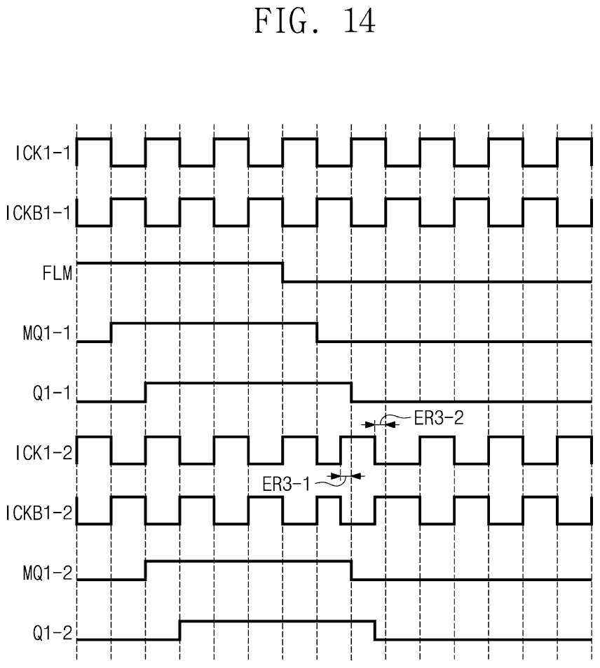

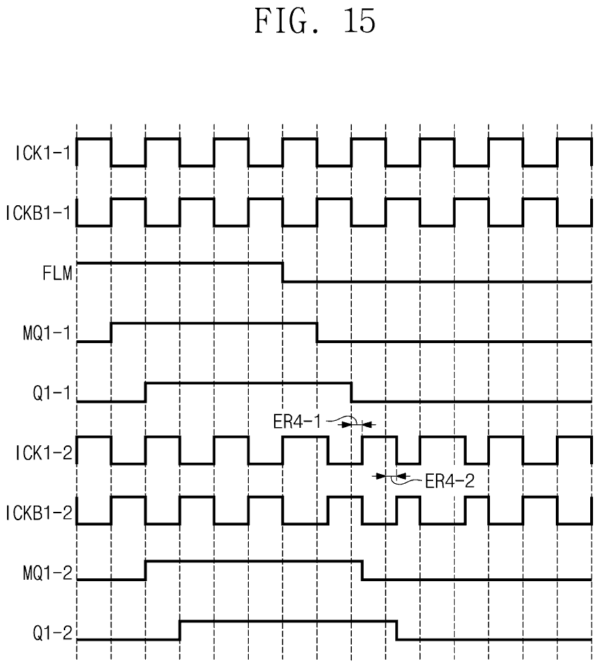

FIG. 13 is a block diagram of a shift register, according to an embodiment. FIG. 14 is a timing diagram for describing an operation of the shift register illustrated in FIG. 13. FIG. 15 is a timing diagram for describing an operation of the shift register illustrated in FIG. 13.

Referring to FIGS. 7 and 13, a first stage ST1a of a shift register 311a according to an embodiment may include a 1-1st flip-flop FF1-1a and a 1-2nd flip-flop FF1-2a. The 1-1st flip-flop FF1-1a may include a 1-1st clock generation unit CLD1-1. The 1-2nd flip-flop FF1-2a may include a 1-2nd clock generation unit CLD1-2.

Referring to FIGS. 13, 14, and 15, the 1-1st and 1-2nd latches LT1-1 and LT1-2 may respectively output the 1-1st intermediate data MQ1-1 and the 1-1st output data Q1-1 in synchronization with a 1-1st internal clock ICK1-1 and a 1-1st internal inversion clock ICKB1-1. The 1-1st internal clock ICK1-1 and the 1-1st internal inversion clock ICKB1-1 may be generated from the 1-1st clock generation unit CLD1-1.

The 1-1st clock generation unit CLD1-1 may generate the 1-1st internal clock ICK1-1 and the 1-1st internal inversion clock ICKB1-1. The 1-1st and 1-2nd latches LT1-1 and LT1-2 may respectively output the 1-1st intermediate data MQ1-1 and the 1-1st output data Q1-1 in synchronization with the 1-1st internal clock ICK1-1 and the 1-1st internal inversion clock ICKB1-1.

The 1-2nd clock generation unit CLD1-2 may generate a 1-2nd internal clock ICK1-2 and a 1-2nd internal inversion clock ICKB1-2. The 1-3rd and 1-4th latches LT1-3 and LT1-4 may respectively output the 1-2nd intermediate data MQ1-2 and the 1-2nd output data Q1-2 in synchronization with the 1-2nd internal clock ICK1-2 and the 1-2nd internal inversion clock ICKB1-2. FIG. 14 and FIG. 15 respectively illustrate a case in which errors occur in the 1-2nd internal clock ICK1-2 and the 1-2nd internal inversion clock ICKB1-2.

In a 3-1st error period ER3-1, the 1-1st internal clock ICK1-1 may have a low level, and the 1-2nd internal clock ICK1-2 may have a high level. In the 3-1st error period ER3-1, the 1-2nd internal clock ICK1-2 may have a high level, and thus the 1-2nd intermediate data MQ1-2 may maintain a high level as it is.

In a 3-2nd error period ER3-2, the 1-1st internal inversion clock ICKB1-1 may have a low level, and the 1-2nd internal inversion clock ICKB1-2 may have a high level. In the 3-2nd error period ER3-2, the 1-2nd internal inversion clock ICKB1-2 may have a high level and the 1-2nd intermediate data MQ1-2 may have a low level, and thus the 1-2nd output data Q1-2 may change to a low level.

In a 4-1 st error period ER4-1, the 1-1st internal clock ICK1-1 may have a high level, and the 1-2nd internal clock ICK1-2 may have a low level. In the 4-1st error period ER4-1, the 1-2nd internal clock ICK1-2 may have a low level, and thus the 1-2nd intermediate data MQ1-2 may maintain a high level as it is.

In a 4-2nd error period ER4-2, the 1-1st internal inversion clock ICKB1-1 may have a high level, and the 1-2nd internal inversion clock ICKB1-2 may have a low level. In the 4-2nd error period ER4-2, the 1-2nd internal inversion clock ICKB1-2 may have a low level, and thus the 1-2nd output data Q1-2 may maintain a high level as it is.

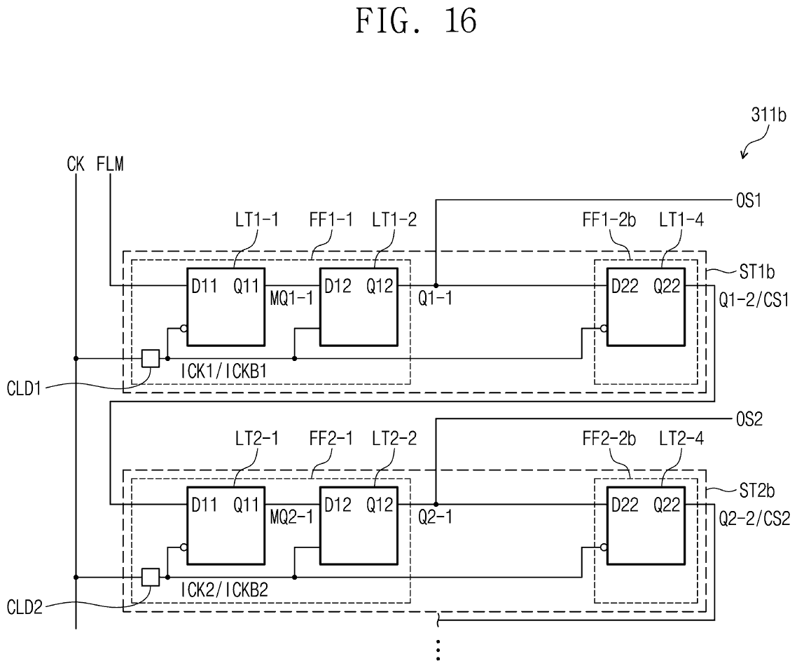

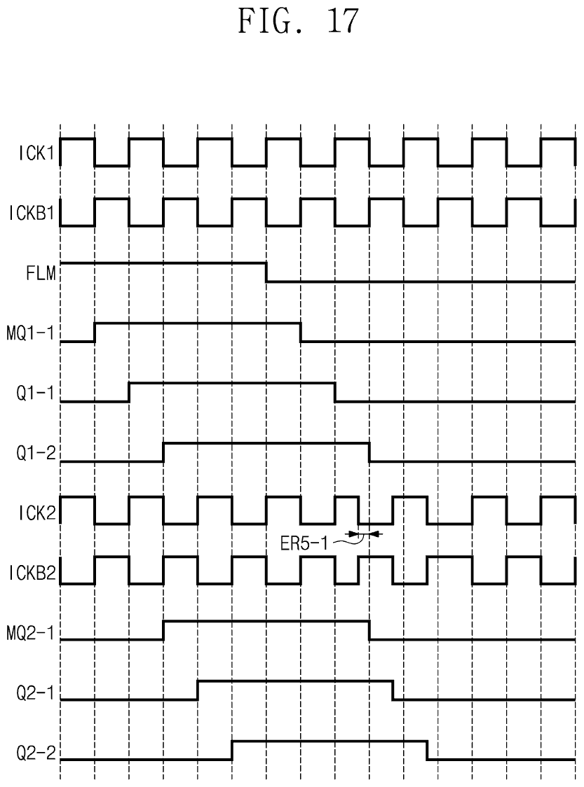

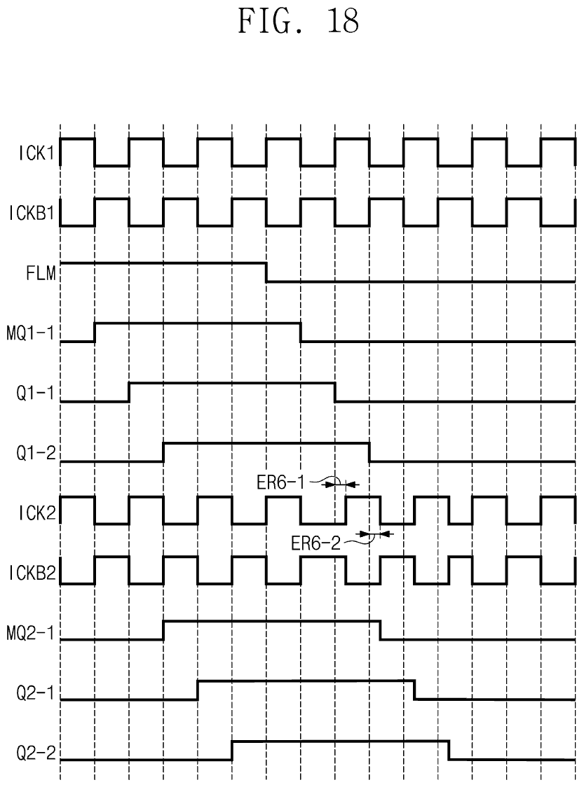

FIG. 16 is a block diagram of a shift register, according to an embodiment. FIG. 17 is a timing diagram for describing an operation of the shift register illustrated in FIG. 16. FIG. 18 is a timing diagram for describing an operation of the shift register illustrated in FIG. 16. FIG. 17 and FIG. 18 respectively illustrate a case in which errors occur in the second internal clock ICK2 and the second internal inversion clock ICKB2.

Referring to FIG. 16, a first stage ST1b of a shift register 311b may include the 1-1st flip-flop FF1-1 and a 1-2nd flip-flop FF1-2b, and a second stage ST2b of the shift register 311b may include the 2-1st flip-flop FF2-1 and a 2-2nd flip-flop FF2-2b. A configuration of the 1-1st and 2-1st flip-flops FF1-1 and FF2-1 illustrated in FIG. 16 is similar to the configuration of the 1-1st and 2-1st flip-flops FF1-1 and FF2-1 illustrated in FIG. 8, and thus redundant descriptions are omitted for descriptive convenience.

The first stage ST1b may receive the start signal FLM and may output the first output signal OS1 and the first carry signal CS1. The second stage ST2b may receive the first carry signal CS1 and may output the second output signal OS2 and the second carry signal CS2.

As an example, each of the 1-2nd and 2-2nd flip-flops FF1-2b and FF2-2b may include a latch (e.g., single latch). For example, the 1-2nd flip-flop FF1-2b may include the 1-4th latch LT1-4. The 2-2nd flip-flop FF2-2b may include the 2-4th latch LT2-4.

The 1-4th latch LT1-4 may receive the 1-1st output data Q1-1 from the 1-2nd latch LT1-2 and may output the 1-2nd output data Q1-2. The 1-2nd output data Q1-2 may be data delayed by a predetermined (or selected) time from the 1-1st output data Q1-1. The 2-4th latch LT2-4 may receive the 2-1st output data Q2-1 from the 2-2nd latch LT2-2 and may output the 2-2nd output data Q2-2. The 2-2nd output data Q2-2 may be data delayed by a predetermined (or selected) time from the 2-1st output data Q2-1.

Referring to FIGS. 17 and 18, in a 5-1st error period ER5-1, the first internal inversion clock ICKB1 may have a low level, and the second internal inversion clock ICKB2 may have a high level. In the 5-1st error period ER5-1, the second internal inversion clock ICKB2 may have a high level and the 1-2nd output data Q1-2 may have a high level. Accordingly, the 2-1st intermediate data MQ2-1 may have a high level.

In a 6-1st error period ER6-1, the first internal inversion clock ICKB1 may have a low level, and the second internal inversion clock ICKB2 may have a high level. In the 6-1st error period ER6-1, the second internal inversion clock ICKB2 may have a high level and the 1-2nd output data Q1-2 may have a high level. Accordingly, the 2-1st intermediate data MQ2-1 may have a high level.

In a 6-2nd error period ER6-2, the first internal inversion clock ICKB1 may have a high level, and the second internal inversion clock ICKB2 may have a low level. Because the second internal inversion clock ICKB2 has a low level in the 6-2nd error period ER6-2, the 2-1st intermediate data MQ2-1 may maintain a high level as it is.

According to an embodiment, a hold margin corresponding to half of the horizontal scan period HP (scc FIG. 11) may be additionally ensured by additionally providing the 1-2nd flip-flop FF1-2b. Accordingly, although the first internal inversion clock ICKB1 and the second internal inversion clock ICKB2 have different phases from each other in the 6-1st error period ER6-1, the 2-1st latch LT2-1 may receive the 1-2nd output data Q1-2 delayed by a predetermined (or selected) time from the 1-1st output data Q1-1 and may output the 2-1st intermediate data MQ2-1. Accordingly, the 2-1st intermediate data MQ2-1 may maintain a high level as it is.

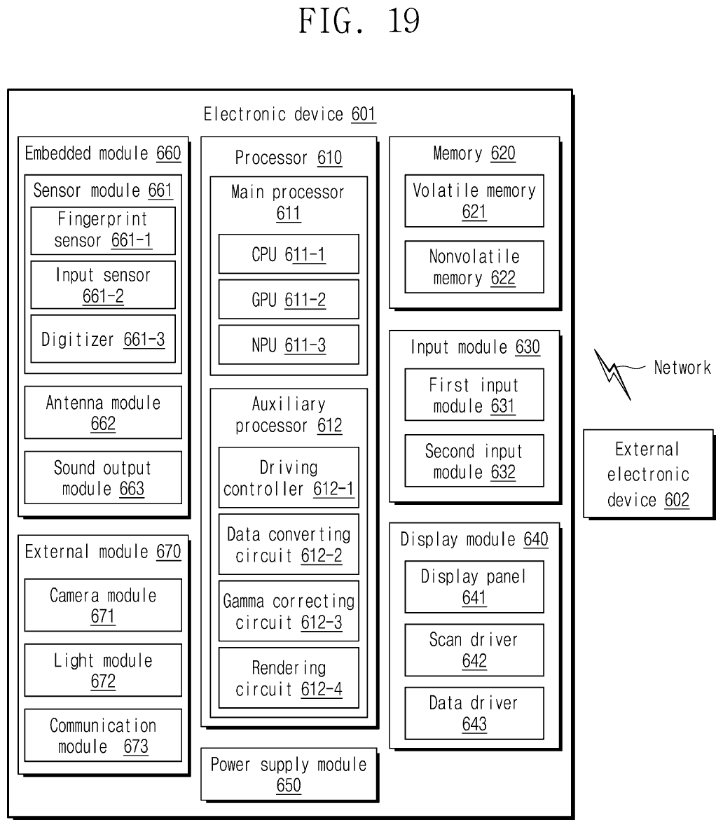

FIG. 19 is a block diagram of an electronic device, according to an embodiment.

Referring to FIG. 19, an electronic device 601 may output various pieces of information through a display module 640 within an operating system. In case that a processor 610 executes an application stored in a memory 620, the display module 640 may provide application information to a user through a display panel 641.

The processor 610 may obtain an external input through an input module 630 or a sensor module 661 and execute an application corresponding to the external input. For example, in case that the user selects a camera icon displayed on the display panel 641, the processor 610 may obtain a user input through an input sensor 661-2 and activates a camera module 671. The processor 610 may deliver image data corresponding to a captured image obtained through the camera module 671 to the display module 640. The display module 640 may display an image corresponding to the captured image through the display panel 641.

For another example, in case that personal information is authenticated on the display module 640, a fingerprint sensor 661-1 may obtain entered fingerprint information as input data. The processor 610 may compare input data obtained through the fingerprint sensor 661-1 with authentication data stored in the memory 620 and executes an application based on the comparison result. The display module 640 may display information, which is executed according to the logic of the application, through the display panel 641.

For another example, in case that a music streaming icon displayed on the display module 640 is selected, the processor 610 may obtain a user input through the input sensor 661-2 and activates the music streaming application stored in the memory 620. In case that a music play command is input by the music streaming application, the processor 610 may provide sound information corresponding to the music play command to the user by activating a sound output module 663.

The operation of the electronic device 601 has been briefly described above. Hereinafter, a configuration of the electronic device 601 will be described in detail. Some of components of the electronic device 601, which will be described below, may be integrated and provided as one configuration, or the one configuration may be provided to be separated into two or more configurations.

Referring to FIG. 19, the electronic device 601 may communicate with an external electronic device 602 through a network (e.g., a short-range wireless communication network or a long-range wireless communication network). According to an embodiment, the electronic device 601 may include the processor 610, the memory 620, the input module 630, the display module 640, a power supply module 650, an embedded module 660, and an external module 670. According to an embodiment, in the electronic device 601, at least one of the above-described components may be omitted, or one or more other components may be added. According to an embodiment, some (e.g., the sensor module 661, an antenna module 662, or the sound output module 663) of the components described above may be integrated into another component (e.g., the display module 640).

The processor 610 may execute software to control at least another component (e.g., hardware or software component) of the electronic device 601 connected to the processor 610, and may process and calculate various types of data. According to an embodiment, as at least part of data processing or calculation, the processor 610 may store instructions or data received from other components (e.g., the input module 630, the sensor module 661 or a communication module 673) into a volatile memory 621, may process instructions or data stored in the volatile memory 621. The result data may be stored in a nonvolatile memory 622.

The processor 610 may include a main processor 611 and an auxiliary processor 612. The main processor 611 may include one or more of a central processing unit (CPU) 611-1 or an application processor (AP). The main processor 611 may further include one or more of a graphic processing unit (GPU) 611-2, a communication processor (CP), and an image signal processor (ISP). The main processor 611 may further include a neural processing unit (NPU) 611-3. The NPU 611-3 may be a processor that is specialized in processing an artificial intelligence model. The artificial intelligence model may be generated through machine learning. The artificial intelligence model may include artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure. At least two of the processing units and the processors that are described above may be implemented as one integrated component (e.g., a single chip) or may be implemented as independent components (e.g., multiple chips).

The auxiliary processor 612 may include a driving controller 612-1. The driving controller 612-1 may include an interface converting circuit and a timing control circuit. The driving controller 612-1 may receive an image signal from the main processor 611, may convert the data format of the image signal so as to be suitable for the interface specifications with the display module 640, and may output image data. The driving controller 612-1 may output various control signals required to drive the display module 640. The configuration of the driving controller 612-1 is substantially similar to the driving controller 100 shown in FIG. 2, and thus detailed descriptions are omitted to avoid redundancy.

The auxiliary processor 612 may further include a data converting circuit 612-2, a gamma correcting circuit 612-3, and a rendering circuit 612-4. The data converting circuit 612-2 may receive the image data from the driving controller 612-1 and may compensate for the image data such that an image is displayed at a desired luminance according to characteristics of the electronic device 601 or setting of the user or may convert the image data to reduce power consumption or compensate for afterimages. The gamma correcting circuit 612-3 may convert the image data, a gamma reference voltage, or the like such that the image displayed on the electronic device 601 has desired gamma characteristics. The rendering circuit 612-4 may receive the image data from the driving controller 612-1 and may render the image data in consideration of a pixel arrangement of the display panel 641 applied to the electronic device 601. At least one of the data converting circuit 612-2, the gamma correcting circuit 612-3, and the rendering circuit 612-4 may be integrated into another component (e.g., the main processor 611 or the driving controller 612-1). At least one of the data converting circuit 612-2, the gamma correcting circuit 612-3, and the rendering circuit 612-4 may be integrated into a data driver 643.

The memory 620 may store various pieces of data, which are used by at least one component (e.g., the processor 610 or the sensor module 661) of the electronic device 601 and input data or output data for commands related thereto. The memory 620 may include at least one or more of the volatile memory 621 and the nonvolatile memory 622.

The input module 630 may receive, from the outside (e.g., the user or the external electronic device 602) of the electronic device 601, commands or data to be used in a components (e.g., the processor 610, the sensor module 661, or the sound output module 663) of the electronic device 601.

The input module 630 may include a first input module 631, through which the commands or data are input from the user, and a second input module 632 through which the commands or data are input from the external electronic device 602. The first input module 631 may include a microphone, a mouse, a keyboard, a key (e.g., a button), or a pen (e.g., a passive pen or an active pen). The second input module 632 may support a designated protocol capable of being connected to the external electronic device 602 by wire or wirelessly. According to an embodiment, the second input module 632 may include a high definition multimedia interface (HDMI), a universal serial bus (USB) interface, a secure digital (SD) card interface, or an audio interface. The second input module 632 may include a connector that may be physically connected to the external electronic device 602, for example, an HDMI connector, a USB connector, an SD card connector, or an audio connector (e.g., a headphone connector).

The display module 640 may provide visual information to the user. The display module 640 may include the display panel 641, a scan driver 642, and the data driver 643. The display module 640 may further include a window, a chassis, a bracket, or the like for protecting the display panel 641. The display module 640 may further include a light emitting driver, a voltage generator, and the like. The voltage generator may output various voltages (e.g., the first and second driving voltages ELVDD and ELVSS (see FIG. 3)) required to drive the display panel 641. The configuration of the display panel 641, the scan driver 642, the data driver 643, and the voltage generator is substantially similar to the configuration of the display panel DP, the gate driver 300, the data driver 200, and the voltage generator 400 shown in FIG. 2, and thus redundant descriptions are omitted for descriptive convenience.

The power supply module 650 may supply power to the components of the electronic device 601. The power supply module 650 may include a battery that charges a power voltage. The battery may include a non-rechargeable primary cell, a rechargeable secondary cell, a fuel cell, or the like. The power supply module 650 may include a power management integrated circuit (PMIC). The PMIC may supply optimized power to the above-described modules and modules which will be described below. The power supply module 650 may include a wireless power transmission/reception member electrically connected to the battery. The wireless power transmission/reception member may include multiple coil-shaped antenna radiators.

The electronic device 601 may further include the embedded module 660 and the external module 670. The embedded module 660 may include the sensor module 661, the antenna module 662, and the sound output module 663. The external module 670 may include the camera module 671, a light module 672, and the communication module 673.

The sensor module 661 may detect an input from the user's body or an input from a pen among the first input module 631, and may generate an electrical signal or data value corresponding to the input. The sensor module 661 may include at least one of the fingerprint sensor 661-1, the input sensor 661-2, and a digitizer 661-3.

The fingerprint sensor 661-1 may generate a data value corresponding to a fingerprint of the user. The fingerprint sensor 661-1 may include one of an optical-type fingerprint sensor, or a capacitance-type fingerprint sensor.

The input sensor 661-2 may generate a data value corresponding to coordinate information of an input by a body of the user or an input by a pen. The input sensor 661-2 may generate the change in capacitance due to the input as the data value. The input sensor 661-2 may sense an input by a passive pen or may transmit or receive data to or from an active pen.

The input sensor 661-2 may also measure a biometric signal such as blood pressure, moisture, or body fat. For example, in case that the user touches a part of the body to a sensor layer or sensing panel and does not move during a specific period, the input sensor 661-2 may detect the biometric signal and may output information desired by the user to the display module 640 based on a changes in electric fields caused by the part of the body.

The digitizer 661-3 may generate the data value corresponding to coordinate information of an input by the pen. The digitizer 661-3 may generate an electromagnetic change amount due to the input as the data value. The digitizer 661-3 may sense input by the passive pen or transmit or receive data to or from the active pen.

At least one of the fingerprint sensor 661-1, the input sensor 661-2, and the digitizer 661-3 may be implemented as a sensor layer formed on the display panel 641 through a subsequent process. The fingerprint sensor 661-1, the input sensor 661-2, and the digitizer 661-3 may be disposed on the upper side of the display panel 641, and one (e.g., the digitizer 661-3) of the fingerprint sensor 661-1, the input sensor 661-2, and the digitizer 661-3 may be disposed on the lower side of the display panel 641.

At least two or more of the fingerprint sensor 661-1, the input sensor 661-2, and the digitizer 661-3 may be formed to be integrated into a single sensing panel through the same process. In case of being integrated into a single sensing panel, the sensing panel may be disposed between the display panel 641 and a window disposed on the upper side of the display panel 641. According to an embodiment, the sensing panel may be disposed on a window, and the position of the sensing panel is not limited thereto.

At least one of the fingerprint sensor 661-1, the input sensor 661-2, and the digitizer 661-3 may be built into the display panel 641. For example, at least one of the fingerprint sensor 661-1, the input sensor 661-2, and the digitizer 661-3 may be simultaneously formed through a process of forming elements (e.g., a light emitting element, a transistor, or the like) included in the display panel 641.

Besides, the sensor module 661 may generate an electrical signal or a data value corresponding to the internal state or external state of the electronic device 601. For example, the sensor module 661 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The antenna module 662 may include one or more antennas to transmit or receive the signal or power to or from an external source. According to an embodiment, the communication module 673 may transmit or receive the signal to or from the external electronic device through the antenna suitable for a communication method. An antenna pattern of the antenna module 662 may be integrated into the input sensor 661-2 or a single component (e.g., the display panel 641) of the display module 640.

The sound output module 663 may be a device for outputting an audio signal to the outside of the electronic device 601 and, for example, may include a speaker used for general purposes, such as multimedia playback or recording playback, and a receiver used only for receiving a call. According to an embodiment, the receiver may be implemented separately from the speaker or may be integrated with the speaker. A sound output pattern of the sound output module 663 may be integrated into the display module 640.

The camera module 671 may shoot (or capture) a still image or a video image. According to an embodiment, the camera module 671 may include one or more lenses, an image sensor, or an image signal processor. The camera module 671 may further include an infrared camera capable of measuring the presence or absence of the user, a position of the user, a gaze of the user, or the like.

The light module 672 may provide light. The light module 672 may include a light emitting diode or a xenon lamp. The light module 672 may operate in conjunction with the camera module 671 or may operate independently from the camera module 671.

The communication module 673 may support establishing a wired or wireless communication channel between the electronic device 601 and the external electronic device 602 and performing communication through the established communication channel. The communication module 673 may include one or all of wireless communication modules such as a cellular communication module, a short-range wireless communication module, or a global navigation satellite system (GNSS) communication module, or wired communication modules such as a local area network (LAN) communication module or a power line communication module. The communication module 673 may communicate with the external electronic device 602 through a short-range communication network such as Bluetooth, WiFi direct, or infrared data association (IrDA) or a long-range communication network such as a cellular network, Internet, or a computer network (e.g., the LAN or a wide area network (WAN)). The above-mentioned various communication modules 673 may be implemented into one chip or may be respectively implemented into separate chips.

The input module 630, the sensor module 661, the camera module 671, and the like may be utilized to control an operation of the display module 640 in conjunction with the processor 610.

The processor 610 may output commands or data to the display module 640, the sound output module 663, the camera module 671, or the light module 672 based on input data received from the input module 630. For example, the processor 610 may generate image data in response to input data applied through a mouse, an active pen, or the like to output the generated image data to the display module 640 or may generate command data in response to the input data to output the generated command data to the camera module 671 or the light module 672. In case that no input data is received from the input module 630 during a specific period, the processor 610 may switch an operation mode of the electronic device 601 to a low-power mode or a sleep mode to reduce power consumed in the electronic device 601.

The processor 610 may output commands or data to the display module 640, the sound output module 663, the camera module 671, or the light module 672 based on sensing data received from the sensor module 661. For example, the processor 610 may compare authentication data authorized by the fingerprint sensor 661-1 with the authentication data stored in the memory 620, and then may execute an application according to the comparison result. The processor 610 may execute commands or may output corresponding image data to the display module 640 based on sensing data sensed by the input sensor 661-2 or the digitizer 661-3. In case that the sensor module 661 includes a temperature sensor, the processor 610 may receive temperature data regarding the measured temperature from the sensor module 661 and may further perform luminance correction on image data based on the temperature data.

The processor 610 may receive measurement data regarding the presence or absence of the user, the user's location, and the user's gaze from the camera module 671. The processor 610 may further perform luminance correction on the image data based on the measurement data. For example, the processor 610 that determines the presence or absence of the user through an input from the camera module 671 may output image data, of which the luminance is corrected, to the display module 640 through the data converting circuit 612-2 or the gamma correcting circuit 612-3.

Some of the components may be connected to each other through communication methods between peripheral devices, for example, a bus, a general purpose input/output (GPIO), a serial peripheral interface (SPI), a mobile industry processor interface (MIPI), or an ultra-path interconnect (UPI) link and may exchange a signal (e.g., commands or data) between each other. The processor 610 may communicate with the display module 640 through a mutually promised interface, and for example, may use any one of the above-described communication methods, and embodiments are not limited to the above-described communication methods.

The electronic device 601 according to various embodiments disclosed in the specification may be implemented with various types of devices. The electronic device 601 may include, for example, at least one of a portable communication device (e.g., a smart phone), a computer device, a portable multimedia device, a portable medical device, a camera, a wearable device, or a home appliance. The electronic device 601 according to an embodiment of this specification may not be limited to the above-described devices.

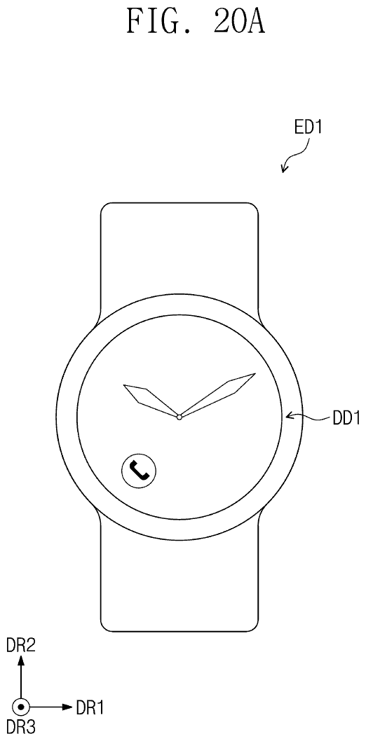

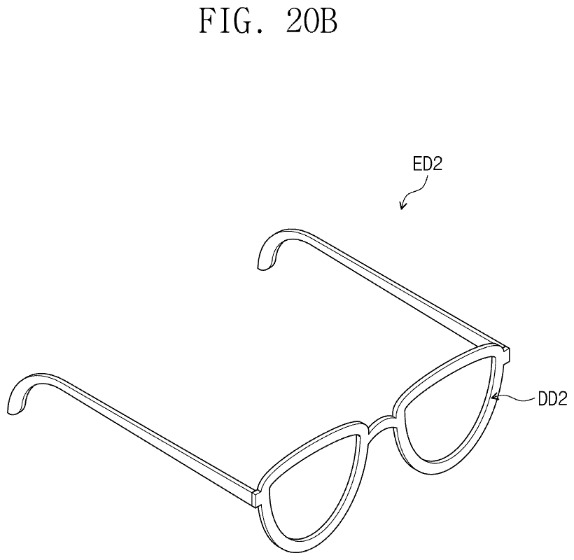

FIG. 20A is a drawing showing a smart watch ED1 employing a display device DD1, according to an embodiment. FIG. 20B is a drawing showing a glasses-type virtual reality device ED2 employing a display device DD2, according to an embodiment.

Referring to FIG. 20A, the smart watch ED1 may employ (or include) the display device DD1, and the display device DD1 may have the structure illustrated in FIGS. 1 to 18.

Referring to FIG. 20B, the virtual reality device ED2 may include a left-eye lens, a right-eye lens, and a frame. Each of the left-eye lens and the right-eye lens may adopt the display device DD2, and the display device DD2 may have the structure shown in FIGS. 1 to 18.

Although an embodiment has been described for illustrative purposes, those skilled in the art will appreciate that various modifications, and substitutions are possible, without departing from the scope and spirit of the disclosure as disclosed in the accompanying claims. Accordingly, the technical scope of the disclosure is not limited to the detailed description of this specification, but should be defined by the claims.

According to an embodiment, a shift register may further include a flip-flop for outputting a carry signal delayed by a predetermined (or selected) time from an output signal in addition to a flip-flop for outputting the output signal, thereby additionally having a hold margin corresponding to half of a horizontal scan period. As a result, the shift register may output output signals sequentially in case that a clock is partially delayed.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. A display device comprising:
a display panel including a pixel;
a gate driver including a shift register that outputs output signals; and
a data driver that supplies a data voltage to the pixel,
wherein the shift register includes:
a first stage that receives a start signal and outputs a first output signal among the output signals and a first carry signal; and
a second stage that receives the first carry signal and outputs a second output signal among the output signals and a second carry signal,
the first carry signal is a signal delayed from the first output signal, and
the second carry signal is a signal delayed from the second output signal.

2. The display device of claim 1, wherein
the first stage includes:
a 1-1st flip-flop that receives the start signal and outputs the first output signal; and
a 1-2nd flip-flop that receives the first output signal and outputs the first carry signal, and
wherein the second stage includes:
a 2-1 st flip-flop that receives the first carry signal and outputs the second output signal; and
a 2-2nd flip-flop that receives the second output signal and outputs the second carry signal.

3. The display device of claim 2, wherein the 1-1st flip-flop includes:
a 1-1st latch that receives the start signal and outputs a 1-1st intermediate data; and
a 1-2nd latch that receives the 1-1st intermediate data and outputs a 1-1st output data as the first output signal.

4. The display device of claim 3, wherein the 1-2nd flip-flop includes:
a 1-3rd latch that receives the 1-1st output data and outputs a 1-2nd intermediate data; and
a 1-4th latch that receives the 1-2nd intermediate data and outputs a 1-2nd output data as the first carry signal.

5. The display device of claim 3, wherein the 1-2nd flip-flop includes:
a 1-4th latch that receives the 1-1st output data and outputs a 1-2nd output data as the first carry signal.

6. The display device of claim 2, wherein
the first stage includes a first clock generator that receives an external clock,
the first clock generator generates a first internal inversion clock from the external clock, and generates a first internal clock from the first internal inversion clock,
the second stage includes a second clock generator that receives the external clock, and
the second clock generator generates a second internal inversion clock from the external clock, and generates a second internal clock from the second internal inversion clock.

7. The display device of claim 6, wherein
the 1-1st flip-flop and the 1-2nd flip-flop respectively output the first output signal and the first carry signal in synchronization with the first internal clock and the first internal inversion clock, and
the 2-1st flip-flop and the 2-2nd flip-flop respectively output the second output signal and the second carry signal in synchronization with the second internal clock and the second internal inversion clock.

8. The display device of claim 2, wherein
the 1-1st flip-flop includes a 1-1st clock generator that receives an external clock,
the 1-1st clock generator generates a 1-1st internal inversion clock from the external clock, and generates a 1-1st internal clock from the 1-1st internal inversion clock,
the 1-2nd flip-flop includes a 1-2nd clock generator that receives the external clock, and
the 1-2nd clock generator generates a 1-2nd internal inversion clock from the external clock, and generates a 1-2nd internal clock from the 1-2nd internal inversion clock.

9. The display device of claim 8, wherein
the 1-1st flip-flop outputs the first output signal in synchronization with the 1-1st internal clock and the 1-1st internal inversion clock, and
the 1-2nd flip-flop outputs the first carry signal in synchronization with the 1-2nd internal clock and the 1-2nd internal inversion clock.

10. The display device of claim 2, wherein
the 1-1st flip-flop operates at a rising edge of an external clock, and
the 1-2nd flip-flop operates at a falling edge of the external clock.

11. The display device of claim 1, wherein
the shift register receives an external clock,
a horizontal scan period is defined by the external clock,
the first carry signal is delayed by half the horizontal scan period from the first output signal, and
the second carry signal is delayed by half the horizontal scan period from the second output signal.

12. The display device of claim 11, wherein
the second output signal is delayed by the horizontal scan period from the first output signal, and
the second carry signal is delayed by the horizontal scan period from the first carry signal.

13. The display device of claim 1, wherein the gate driver further includes:
a level shifter that receives the output signals and shifts voltage levels of the output signals; and
an output buffer that receives the output signals having the shifted voltage levels and outputs a scan signal.

14. A display device comprising:
a display panel including a pixel;
a gate driver including a shift register; and
a data driver that supplies a data voltage to the pixel, wherein
the shift register includes a plurality of stages,
each of the stages includes:
a first flip-flop that receives a previous carry signal and outputs an output signal; and
a second flip-flop that receives the output signal and outputs a current carry signal, and
the current carry signal is a signal delayed from the output signal.

15. The display device of claim 14, wherein the first flip-flop includes:
a 1-1st latch that receives the previous carry signal and outputs a 1-1st intermediate data; and
a 1-2nd latch that receives the 1-1st intermediate data and outputs a 1-1st output data as a first output signal.

16. The display device of claim 15, wherein the second flip-flop includes:
a 1-3rd latch that receives the 1-1st output data and outputs a 1-2nd intermediate data; and
a 1-4th latch that receives the 1-2nd intermediate data and outputs a 1-2nd output data as the current carry signal.

17. The display device of claim 15, wherein the second flip-flop includes:
a 1-4th latch that receives the 1-1st output data and outputs a 1-2nd output data as the current carry signal.

18. The display device of claim 14, wherein
the shift register receives an external clock,
a horizontal scan period is defined by the external clock, and
the current carry signal is delayed by half the horizontal scan period from the output signal.

19. The display device of claim 14, wherein the gate driver includes:
a level shifter that receives the output signal and shifts a voltage level of the output signal; and
an output buffer that receives the output signal having the shifted voltage level and outputs a scan signal.

20. An electronic device comprising:
a display panel including a pixel;
a gate driver including a shift register that outputs output signals;
a data driver that supplies a data voltage to the pixel;
a driving controller that receives an image signal and a control signal and controls operations of the gate driver and the data driver; and
a main processor that provides the image signal and the control signal to the driving controller, wherein
the shift register includes:
a first stage that receives a start signal and outputs a first output signal among the output signals and a first carry signal; and
a second stage that receives the first carry signal and outputs a second output signal among the output signals and a second carry signal,
the first carry signal is a signal delayed from the first output signal, and
the second carry signal is a signal delayed from the second output signal.
